(19) United States
(12) Patent Application Publication
(10) Pub. No.: US 2020/0290023 A1
(43) Pub. Date: Sep. 17, 2020

(54) CERIUM-CONTAINING HYDRODESULFURIZATION CATALYSTS AND USES

(71) Applicant: KING FAHD UNIVERSITY OF PETROLEUM AND MINERALS, Dhahran (SA)

(72) Inventors: KHALID R. ALHOOSHANI, Dhahran (SA); Saheed Adewale GANIYU, Dhahran (SA); Abdulkadir TANIMU, Dhahran (SA)

(73) Assignee: KING FAHD UNIVERSITY OF PETROLEUM AND MINERALS, Dhahran (SA)

(21) Appl. No.: 16/351,721

(22) Filed: Mar. 13, 2019

(51) Int. Cl. B01J 23/887; B01J 35/10; B01J 37/16; B01J 37/20; B01J 37/02

(52) U.S. Cl. CPC B01J 23/8871; B01J 35/1061; B01J 35/1038; B01J 35/1019; B01J 37/08; B01J 37/20; B01J 37/0207; B01J 37/0209; B01J 37/16

(57) ABSTRACT

Catalysts for hydrodesulfurization (HDS), e.g., of fuel such DBT in a batch reactor, may include Ce-modified SBA CoMo-sulfided catalysts. The dispersion and catalytic activity of the active species (CoMoS₂) may be influenced by the Ce—Si network in the support. The physico-chemical properties of such catalysts—textural properties, crystallinity, metal oxide reducibility, and Mo phases—were established, and BET surface area, X-ray diffraction (XRD), and Raman spectroscopy analysis showed up to 2.5 wt. % Ce incorporation into the Si-network in SBA-15. Up to 2.5 wt. % Ce loading on the SBA-15 support can provide large BET surface area and total pore volume. The metal oxide reducibility and MoS₂ phase in the sulfided 2.5Ce—S—CoMo catalyst indicate moderate metal-support interaction at 2.5Ce wt. %. Improved HDS activity was shown with Ce loading up to 2.5 wt. %, possibly due to Ce's facilitation of metal oxide reduction and dispersion of the MoS₂ active phase via metal-support interaction.

The gracious support provided by the King Fahd University of Petroleum and Minerals (KFUPM) in funding this work through project No. DSRNUS15105 is acknowledged.

### BACKGROUND OF THE INVENTION

### Field of the Invention

The present disclosure relates to hydrodesulfurization (HDS), particularly ultradeep HDS, and catalysts for carrying out HDS, as well as the manufacture of such catalysts and the products formed by the hydrodesulfurization. The catalysts may comprise ceria and/or a mesoporous silica support, such as SBA-15.

### Description of the Related Art

World energy demand has risen with increasing population and industrialization. Fossil fuels continue to be a major source of energy. Fossil fuels have recently shown increasing amounts of sulfur due to continuous oil exploration. The presence of sulfur in fuels hampers the hydrocracking process, i.e., the method of producing low molecular weight and more volatile fractions, such as natural gas and gasolines, from crude oils, due to catalyst deactivation. In addition, refinery equipment and pipelines are corroded by sulfur in fuels.

In the environment, transportation fuels with high sulfur contents may pollute more severely by releasing sulfur oxides, such as sulfur(IV)oxide, and consequently acid rain, causing severe health issues and ecological damage. Regular use of high sulfur fuels in motor vehicles can also lead to knocking in vehicle engines.

Regulatory bodies, such as the European commission, have made efforts to limit the amount of sulfur emitted in vehicular exhaust, particularly from new vehicles. The European Emission Standard (Euro VI) for clean fuel specifications require less than 10 ppm S in transportation fuel, levels already implemented in United States and Japan, which are also part of the vision 2020 for the Kingdom of Saudi Arabia. These stringent sulfur regulations have put refineries in the challenging situation of searching for new hydrotreating catalysts that can work effectively while bringing down the sulfur level below 10 ppm.

Conventional catalyst supports used in most refineries are based on alumina, due to alumina's substantial Lewis acidity, as well as its large surface area and porosity. However, research indicates that alumina-supported catalysts suffer rapid deactivation due to strong metal support interactions between alumina and the active metals. Therefore, ongoing research has been focused on developing new, large surface area supports combining both support acidity and moderate metal-support interaction properties.

Silica based mesoporous materials with large surface area and relatively weak acidity such as SBA-15 have recently gained much attention as active metal support for hydrodesulfurization (HDS) applications. Silica supports have been modified to incorporate Al, Ti, and Zr, into the framework of the mesoporous silica in an effort to moderate the metal-support interactions. The impact of heteroatoms, i.e., non-silica atoms, and preparative conditions on both support properties and active metals dispersion are continuously under investigation.

Recent studies on the role of Al on the support properties of KIT-6 mesoporous silica revealed that metal incorporation increased support interaction with the active phases, and subsequently enhanced the HDS performance of the CoMo catalyst. Inserting tetragonal zirconia into alumina support frameworks using zirconium isopropoxide, reportedly decreases the Mo-alumina interaction, improving dispersion of the NiMoS phase.

Increased MoO₃ dispersion into an MCM-41 support framework via the incorporation of alumina, niobia, titania and zirconia has been reported. The increased dispersion observed upon incorporation of these heteroatoms has been explained based on the increased active metal-support interaction. By adjusting the pH of reaction mixture, a large amount of Al and Ti was incorporated into the mesoporous walls of pure silica SBA-15, almost exclusively in 4-coordinated environments, to obtain highly ordered, mesostructured material with uniform size distribution and high surface area. High dispersion and uniform distribution of octahedral Ni and Mo species on SBA-15 has been observed by attaching Ti to an SBA-15 framework. The NiMo/TiSBA-15 catalyst showed better catalytic performance in HDS and hydrodenitrogenation (HDN) than its NiMo/SBA-15 counterpart.

Different crystal sizes of mesoporous Al-SBA-16 supports have been developed for HDS of dibenzothiophene (DBT) and 4,6-dimethyldibenzothiophene (4,6-DMDBT). After Ni and Mo impregnation of the support, the catalysts having the smallest crystal sizes showed the highest surface area, acidity, and HDS performance for both DBT and 4,6-DMDBT. Further attempts have been made to improve HDS and related reaction catalysis.

U.S. Pat. No. 9,376,636 to Marchand et al. (Marchand I), also published as US 2014/0183100 A1 and WO 2012/085357 A1, discloses hydrodesulfurizing gasoline cut(s) with a catalyst comprising, in its oxide form, metal(s) from group VIB and/or VIII of the periodic table, present in the form of at least one polyoxometalate of the formula (HₕXₓMₘO_{y})^{q-}, wherein X is P, Si, B, Ni, or Co, M is Mo, W, Ni, and/or Co, h is an integer from 0 to 12, x is an integer from 0 to 4, m is an integer 5, 6, 7, 8, 9, 10, 11, 12 and/or 18, y is an integer of 17 to 72 and q is an integer of 1 to 20, the polyoxometalates being present within a mesostructured silicon oxide matrix having a pore size of 1.5 to 50 nm and having amorphous walls of thickness 1 to 30 nm, the catalyst being sulfured before use in the process.

U.S. Pat. No. 9,340,733 to Marchand et al. (Marchand II), also published as US 2014/0183100 A1 and WO 2012/085357 A1, discloses hydrodesulfurizing gasoil cut(s) with a catalyst as in Marchand I having amorphous walls of thickness within the range 1 to 30 nm, the catalyst being sulfured before use in the process.

While Marchand I and II may describe that the mesostructured silicon oxide matrix comprising the polyoxometalates trapped in its walls, may include porous oxide material preferably formed by alumina, silica, silica-alumina, magnesium, clay, titanium oxide, zirconium oxide, lanthanum oxide, cerium oxide, the aluminum phosphate(s), boron phosphate(s), or a mixture of at least two of the oxides and the alumina-boron oxide combinations, the alumina-titanium mixtures, alumina-zirconia and titanium-zirconia, neither Marchand I nor II exemplify using ceria in a support, nor particularly SBA-15, nor in an amount of 1 to 10 wt. % relative to the total. In addition, Marchand I and II do not disclose a CoMo catalyst supported on mesoporous SBA-15 silica modified to contain ceria in an amount in the range of 0.1 to 10.0 wt. %.

CN 106433751 A by Dong (Dong I) discloses a hydrodesulfurization (HDS) and denitrification (DN) process for diesel oil. A fixed bed reactor is filled with Dong I's catalyst, which comprises a carrier, an active component, and a catalytic aid. Dong I's carrier is a compound or mixture of MSU-G, SBA-15, and HMS. Dong I's active component is a mixture of dimolybdenum nitride MO₂N, tungsten nitride W₂N, molybdenum carbide Mo₂C, and tungsten carbide WC. Dong I's catalytic aid is a mixture of Cr₂O₃, ZrO₂, CeO₂, V₂O₅, and NbOPO₄. Dong I's fixed bed reaction conditions include a reaction temperature of 320 to 360° C., a reaction pressure of 6 to 8 MPa, a hydrogen-oil volume ratio of 300 to 600, and a volume space velocity of 1.0 to 2.5 h⁻¹. Dong I's process can control total sulfur content of diesel oil to lower than 5 ppm, and meanwhile, control the total nitrogen content to within 10 ppm.

CN 106622358 A by Dong (Dong II) discloses a hydrodesulfurization catalyst, comprising a support and an active component which may be selected from the same groups as Dong I. Dong II's active component accounts for 1 to 15 wt. % relative to the support. Dong II's catalyst is capable of reducing total sulfur content of FCC (fluid catalytic cracking) gasoline to 5 ppm and below so that the gasoline meets the gasoline standard G5. Dong II reports the catalyst to not significantly decrease the octane value of FCC gasoline.

While Dong I and II may use a carrier comprising MSU-G, SBA-15, and/or HMS, Neither of the Dong publications describes cerium in these carriers. Instead, Dong's active component is Mo₂N, Mo₂C, or W₂N, combined with WC, whereby Dong's active component is doped with a catalytic acid which is a mixture of Cr₂O₃, ZrO₂, CeO₂, V₂O₅, and NbOPO₄. Neither Dong I nor II disclose a catalyst supported on mesoporous SBA-15 silica modified to contain ceria.

Chem. Select. 2016, 1(20), 6460-6468 by Xiao et al. (Xiao) discloses catalytic steam reforming of long-chain hydrocarbons for hydrogen production for on-board/on-site fuel cell use. Xiao uses SBA-15 supported Ni—Co bi-metal catalysts with different ceria loadings (NC-xCeO₂/SBA-15) prepared via an ethylene-glycol route. Xiao steam reforms n-dodecane to evaluate catalytic performance of catalysts at 24 mL/gcat·h and atmospheric pressure in a fixed-bed tubular reactor using an H₂O/C ratio of 4. The catalyst with 6 wt. % CeO₂ (NC-6CeO₂/SBA-15) exhibits the best activity and stability. Xiao ascribes improved performance for n-dodecane steam reforming to strong interactions between the metal and ceria, controlling metal growth and prevent metal sintering. Xiao reports improved oxidation of deposited coke on metal, likely via ceria's oxygen storage-release capability. However, Xiao does not disclose using its catalyst in hydrodesulfurization, and Xiao's active phase is NiCo—CeO₂, not CoMoS₂.

Appl. Petrochem. Res. 2014, 4, 209-216 by Li et al. (Li) discloses preparing Ni₂P/SBA-15 precursors with Ni₂P loadings of 25 wt. % and an initial P/Ni of 0.8 preparing using nickel nitride as nickel source, diammonium hydrogen phosphide as phosphorus, and mesopore molecular sieve SBA-15 as support. Li introduces Ce into the Ni2P/SBA-15 precursor to prepare mesoporous Ce—Ni₂P/SBA-15 catalysts after temperature-programmed reduction in flowing H₂. An Ni₂P phase only formed in Ce—Ni₂P/SAB-15 catalysts with Ce loadings of 0 to 5 wt %. Ni₂P, while Ni₂P₅ phases formed in the 7 wt % Ce—Ni₂P/SBA-15 catalyst. The surface area and pore volume increased when Ce was added to Ni₂P/SBA-15 catalyst. The strength of the acid sites and total acid amount of Ce—Ni₂P/SBA-15 catalysts increased with increasing Ce loadings. Ce existed Ce³⁺ and Ce⁴ form, Ni in Ni²⁺ and Ni, form, and P in P^{δ-} and P⁵⁺ form. Li reports that adding Ce to the Ni₂P/SBA-15 catalyst decreased its Ni⁸ concentration. Hydrodesulfurization (HDS) activity of dibenzothiophene (DBT) over Ni₂P/SBA-15 catalysts at 300 to 340° C. was negatively affected adding Ce. Li's catalysts exhibited good deep HDS catalytic performance for DBT, with conversions of DBT reaching 98.9% at 380° C. Biphenyl was the main product over Ce—Ni₂P/SBA-15 catalysts and cyclohexylbenzene was the main product over Ni₂P/SBA-15 catalyst at 380° C. Aside from its indicated diminished efficacy relative to cerium-free analogs, Li's catalyst contains phosphorus and does not contain any molybdenum. Li does not specifically disclose doping its carrier in isolation and/or prior to loading the active catalyst metals onto the carrier, instead impregnating already-synthesized, Ni₂P/SBA-15 catalysts with Ce(NO₃)₃.

Catal. Lett. 2008, 124, 24-33 by Huang et al. (Huang) discloses synthesizing MoS₂ hydrodesulfurization (HDS) catalysts promoted with Co, supported on SBA-15 from sulfur-containing Mo sources [ammonium thiomolybdate (ATM), and tetramethylammonium thiomolybdate (TMA™)] and Co complexes cobalt dimethylthiocarbamate to obtain active catalysts. Huang's (Co)—MoS₂/SBA-15 catalysts had catalytic activity for HDS of dibenzothiophene at 623 K and 3.4 MPa H₂. Huang reports that the sequence of impregnation steps has no significant influence on the HDS activity, but using different thiomolybdate precursors significantly affects catalytic activity. Huang's catalysts from TMA™ showed lower HDS activities than those synthesized from ATM, possibly due to pore blocking and the generation of needle-like aggregates of the Co—MoS₂ phase. Huang speculates that forming intermediate MoS₃ is unnecessary to generate catalytically active CoMoS phases, and that the high activity and selectivity for the direct desulfurization pathway of ATM-based catalysts despite the large MoS₂ stacking was due to the larger number of coordinately unsaturated sites. However, Huang does not describe using cerium in any portion of its catalysts, let alone in the carrier or in a particular percentage.

Microporous Mesoporous Mater. 2018, 265, 1-7 by Nguyen et al. (Nguyen) discloses synthesizing Ti-inserted, ordered mesoporous silica SBA-15 (Ti-SBA-15) by a microwave-assisted method as a support to prepare CoMo catalysts and develop catalysts with high hydrodesulfurization (HDS) and controlled hydrodearomatization (HDA) activities. Activity tests were carried in a pressurized fixed-bed flow reactor on 4,6-dimethyldibenzothiophene (4,6-DMDBT), 1-methylnaphthalene, and phenanthrene in HDS and HDA. Nguyen reports CoMo/Ti-SBA-15 to have about 1.35-fold HDS activity and half of HDA activity of CoMo/SBA-15. Titanium was successfully inserted into silica framework of SBA-15, and the SBA-15 mesoporous structure was maintained after insertion of titanium. Molybdenum reduced readily from Mo⁶⁺ to Mo⁴⁺ with incorporation of titanium, increasing the Mo⁴⁺ species and CoMoS phase in sulfided catalysts and enhancing the HDS activity of CoMo/Ti-SBA-15. Ti³⁺ was also observed on CoMo/Ti-SBA-15, which Nguyen believed to indicate TiMoS formation and play a role as new active sites. CoMoS active slabs with shorter length and higher stacking layer were formed on CoMo/Ti-SBA-15 compared to CoMo/SBA-15, resulting in the low HDA activity of CoMo/Ti-SBA-15. Nguyen indicates that modifying its SBA-15 support with titanium decreases the specific surface area and average pore diameter of the support/carrier and of the catalyst. Nguyen does not disclose the use of cerium in its catalysts. Moreover, Nguyen aims to balance hydrodearomatization with hydrodesulfurization to obtain benzene, toluene, and xylenes from light cycle oil, rather than specifically focusing on hydrodesulfurization of fuels.

J. Colloid Interface Sci. 2018, 513, 779-787 by Saleh et al. (Saleh) discloses the role of Co and Mo nanoparticles loaded on activated carbon (AC) on the adsorptive desulfurization ability of sulfur-containing compounds under ambient conditions. The AC was first synthesized and activated, followed by incorporation of the Co and/or Mo nanoparticles. Saleh's composites were evaluated for simultaneous adsorption of sulfur compounds from fuels. The AC/CoMo composite showed better adsorption properties than pure AC, AC/Co and AC/Mo composites for the removal of thiophene (T), benzothiophene (BT), dibenzothiophene (DBT), 5-methyl-1-benzothiophene (MBT), 4,6-dimethyldibenzothiophene (DMDBT) and 4-methyldibenzothiophene (MDBT). The order of the thiophene compounds removal was found to be thiophene <BT<DBT<MBT≤MDBT≤DMDBT. AC/CoMo's enhanced desulfurization performance was attributed to increased surface area achieved through impregnation of both Co and Mo. Saleh does not disclose ceria modified SBA-15 silica as a support for a cobalt-molybdenum HDS catalyst.

Energy Fuels. 2018, 32(11), 11383-11389 by Jalilov et al. (Jalilov) discloses enhancing the efficiency of MoS₂-based catalysts for hydrodesulfurization (HDS) on industrial scale, including changes in catalyst support and doping agents, and synthetically tuning the dispersion of the MoS₂ phase. Jalilov reports the kinetic and mechanistic analysis of HDS on dibenzothiophene (DBT) for different NiMo-supported Ti-SBA-15 catalysts prepared by (1) direct single-pot (SP) synthesis and (2) impregnations of the NiMo phase into the Ti-SBA-15 support. Jalilov repeated both methods with and without citric acid loading to achieve higher dispersion of the active metal sites. Kinetic modeling was performed to two “parallel-series” reactions of DBT, direct desulfurization (DDS), and hydrogenation (HYD), both leading to the final product of cyclohexylbenzene, revealing considerable influence of the catalyst preparation method to both steps of HDS of DBT. Jalilov reports apparent rate constants for DDS k₁′ to be highly dependent upon the synthetic method, and citric acid to contribute strongly to the apparent rate constants for converting a partially hydrogenated dibenzothiophene intermediate, k4′. Jalilov does not disclose the use of ceria, but rather titania, in its supports, and describes NiCo catalysts rather than CoMo catalysts. Beyond failing to describe CoMo catalysts, Jalilov does not disclose SBA-15 supports containing ceria in an amount of from 0.1 to 10.0 wt. %

In light of the above, a need remains for catalysts having cerium incorporated into a mesoporous silica framework, such as SBA-15, particularly for hydrogenation and hydrolysis, and methods of making and using such catalysts. In addition to its redox properties, ceria's acid-base properties may offer possibilities for developing catalysts for applications such as HDS of organosulfur compounds.

### SUMMARY OF THE INVENTION

Aspects of the invention provide catalysts that may comprise: an active component comprising Co and Mo, and suitable to catalyze hydrodesulfurization; a support comprising at least 80 wt. %, based upon total support weight, mesoporous silica and cerium in a range of 0.1 to 10.0 wt. %, or 1.5 to 4.5 wt. %. Such catalysts may be modified in any manner, i.e., with or without any feature or permutation of features, described herein.

The cerium may be present as ceria. The mesoporous silica may have an average pore diameter in a range of from 3 to 20 nm, or 4 to 10 nm, and/or the mesoporous silica may be SBA-15.

Inventive catalysts may be sulfided. Catalysts within the scope of the invention may have a BET surface area in a range of from 110 to 155 m²/g, and/or the support may have a BET surface area in a range of from 640 to 700 (647.1) m²/g. In addition or separately, catalysts within the scope of the invention may have a microporous surface area in a range of from 8.5 to 20 m²/g, and/or the support may have a microporous surface area in a range of from 48.5 to 60 m²/g. In addition or separately, catalysts within the scope of the invention may have an external surface area in a range of from 100 to 145 m²/g, and/or the support may have an external surface area in a range of from 595 to 650 m²/g. In addition or separately, catalysts within the scope of the invention may have a microporous pore volume in a range of from 0.0055 to 0.0105 cm³/g, and/or the support may have a microporous pore volume in a range of from 0.015 to 0.0275 cm³/g. In addition or separately, catalysts within the scope of the invention may have a total pore volume in a range of from 0.305 to 0.375 cm³/g, and/or the support may have a total pore volume in a range of from 0.85 to 1.1 cm³/g. In addition or separately, catalysts within the scope of the invention may have an average pore size in a range of from 7.75 to 12.5 nm, and/or the support may have an average pore size in a range of from 6 to 8 nm.

Aspects of the invention include methods of preparing catalyst, the method comprising: preparing a support comprising at least 80 wt. %, based upon total support weight, mesoporous silica and cerium in a range of 0.1 to 10.0 wt. %; and impregnating the support with a solution comprising a molybdenum salt; impregnating the support with a solution comprising a cobalt salt; and heating to obtain a supported CoMo catalyst suitable for hydrodesulfurization.

The preparing may comprise: mixing a tetraalkylorthosilicate, a surfactant, and a mineral acid, to obtain a silica sol; adding to the silica sol a cerium alkoxide in an amount in a range of from 0.1 to 10 wt. % relative to the tetraalkylorthosilicate, to obtain a cerium-containing silica sol; and heating the cerium-containing mesoporous silica sol at a temperature in a range of from 50 to 100° C.

The tetraalkylorthosilicate may comprise tetramethylorthosilicate, tetraethylorthosilicate, tetrapropylorthosilicate, and/or tetrabutylorthosilicate, the surfactant may be uncharged, the mineral acid may comprise hydrochloric acid, hydrobromic acid, sulfuric acid, and/or the cerium alkoxide may comprise cerium methoxide, cerium ethoxide, cerium propoxide, cerium isopropoxide, cerium sec-butoxide, and/or cerium tert-butoxide.

The preparing may comprise: mixing tetraethylorthosilicate, PEO-PPO-PPO triblock copolymer, and hydrochloric acid to form a solution; adding cerium isopropxide in an amount in the range of 0.1 to 5 wt. % relative to the tetraethylorthosilicate; and heating at a temperature in a range of from 50 to 100° C. to produce the support, wherein the support is cerium-modified mesoporous silica having an average pore diameter in a range of from 4 to 40 nm. In addition or separately, the impregnating may comprise: mixing a suspension of the cerium-modified silica sol in water with an aqueous solution containing equimolar amounts of cobalt (II) chloride and ammonium molybdate(VI). In addition or separately, the heating may comprise stirring at a temperature in a range of from 40 to 60° C. to evaporate solvent, and optionally, calcining to obtain the supported CoMo catalyst.

Inventive methods may further comprise activating the supported CoMo catalyst by a method comprising: reducing the supported CoMo catalyst under a flow of hydrogen in an inert gas at a temperature in a range of 350 to 450° C., to obtain a reduced catalyst; and sulfiding the reduced catalyst, optionally with cyclohexane containing an amount of carbon disulfide in the range of 0.5 to 4 wt. % at a temperature in a range of 300 to 400° C. to produce an activated catalyst.

Aspects of the invention provide hydrodesulfurization methods, comprising: contacting a sulfur-containing hydrocarbon stream with any inventive activated catalyst under hydrogen at a pressure in a range of 2 to 10 MPa and temperature in a range of 300 to 400° C. to thereby reduce a sulfur content of the hydrocarbon stream.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A shows an N₂ adsorption-desorption isotherm for Ce-modified supports within the scope of the invention;

FIG. 1B shows a pore volume-size distribution for Ce-modified supports within the scope of the invention;

FIG. 2A shows an N₂ adsorption-desorption isotherm for Ce-modified supported CoMo catalysts within the scope of the invention;

FIG. 2B shows a pore volume-size distribution for Ce-modified supported CoMo catalysts within the scope of the invention;

FIG. 3A shows wide angle x-ray diffraction (XRD) patterns of supports: (a) SBA-15, i.e., undoped; (b) 1Ce-SBA-15; (c) 2.5Ce-SBA-15; (d) 5Ce-SBA-15; and (e) 10Ce-SBA-15;

FIG. 3B shows wide angle x-ray diffraction (XRD) patterns of supported, sulfided catalysts: (a) S—CoMo, i.e., undoped; (b) 1Ce—S—CoMo; (c) 2.5Ce—S—CoMo; (d) 5Ce—S—CoMo; and (e) 10Ce—S—CoMo;

FIG. 4A shows Raman spectra of supports: (a) SBA-15, i.e., undoped; (b) 1Ce-SBA-15; (c) 2.5Ce-SBA-15; (d) 5Ce-SBA-15; and (e) 10Ce-SBA-15;

FIG. 4B shows Raman spectra of supported, sulfided catalysts: (a) S—CoMo, i.e., undoped; (b) 1Ce—S—CoMo; (c) 2.5Ce—S—CoMo; (d) 5Ce—S—CoMo; and (e) 10Ce—S—CoMo;

FIG. 5A shows Fourier-transform infrared (FT-IR) spectra of supports: (a) SBA-15, i.e., undoped; (b) 1Ce-SBA-15; (c) 2.5Ce-SBA-15; (d) 5Ce-SBA-15; and (e) 10Ce-SBA-15;

FIG. 5B shows Fourier-transform infrared (FT-IR) spectra of supported, sulfided catalysts: (a) S—CoMo, i.e., undoped; (b) 1Ce—S—CoMo; (c) 2.5Ce—S—CoMo; (d) 5Ce—S—CoMo; and (e) 10Ce—S—CoMo;

FIG. 6 shows H₂-temperature-programmed reduction (TPR) of supported, sulfided catalysts: (a) S—CoMo, i.e., undoped; (b) 1Ce—S—CoMo; (c) 2.5Ce—S—CoMo; (d) 5Ce—S—CoMo; and (e) 10Ce—S—CoMo;

FIG. 7A shows a field emissions scanning electron microscope (FE-SEM) image of a supported, sulfided 1Ce—S—CoMo catalyst;

FIG. 7B shows an FE-SEM image of a supported, sulfided 2.5Ce—S—CoMo catalyst;

FIG. 7C shows an FE-SEM image of a supported, sulfided 5Ce—S—CoMo catalyst;

FIG. 7D shows an FE-SEM image of a supported, sulfided 10Ce—S—CoMo catalyst;

FIG. 8A shows an FE-SEM image of a supported, sulfided S—CoMo catalyst (undoped);

FIG. 8B shows an x-ray photoelectron spectroscopy (XPS) spectrum of supported, sulfided S—CoMo catalyst (undoped) showing its Mo phases;

FIG. 9A shows an XPS spectrum of a supported, sulfided 1Ce-s-CoMo catalyst showing its Mo phases;

FIG. 9B shows an XPS spectrum of a supported, sulfided 2.5Ce-s-CoMo catalyst showing its Mo phases;

FIG. 9C shows an XPS spectrum of a supported, sulfided 5Ce-s-CoMo catalyst showing its Mo phases;

FIG. 9D shows an XPS spectrum of a 10Ce-s-CoMo sulfided catalysts showing its Mo phases;

FIG. 10A shows a hydrodesulfurization (HDS) performance plot of Ce-modified SBA-15 supported CoMo catalysts with varied Ce content, within the scope of the invention;

FIG. 10B shows the effect of process temperature on the HDS performance of 2.5C—S—CoMo; and

FIG. 11 shows the reaction mechanism of hydrodesulfurization (HDS) showing parallel reaction pathways.

### DETAILED DESCRIPTION OF THE PREFERRED EMBODIMENTS

Catalysts within the scope of the invention may comprise: an active component comprising Co and Mo, i.e., at least 20, 30, 35, 40, 45, 50, 55, or 60% of either, with the balance of both being no more than 100% of the total active component, the active component and/or entire catalyst being suitable to catalyze hydrodesulfurization; a support comprising at least 80, 82.5, 85, 87.5, 90, 91, 92, 92.5, 93, 94, 95, 94.5, 96, 96.5, 97 wt. % or more, based upon total support weight, mesoporous silica and cerium in a range of 0.1 to 10.0 wt. %, or 1.5 to 4.5 wt. %, and/or at least 0.25, 0.33, 0.5, 0.67, 0.75, 0.85, 0.9, 1, 1.25, 1.33, 1.5, 1.67, 1.75, 1.8, 1.9, 2.0, 2.125, 2.25, 2.33, 2.4, or 2.5 wt. % and/or no more than 4.75, 4.67, 4.5, 4.33, 4.25, 4, 3.75, 3.67, 3.5, 3.33, 3.25, 3.125, 3, 2.85, 2.75, 2.67, or 2.5 wt. % Ce.

The cerium in the inventive supports may be present as ceria, i.e., a cerium oxide, though it will generally be introduced as a Ce (IV) salt, such as a cerium alkoxide. The mesoporous silica may have an average pore diameter in a range of from 2 to 40, 3 to 20, 3 to 15, 4 to 10, 5 to 9, or 6 to 8 nm, and/or the mesoporous silica may be SBA-15.

Inventive catalysts may be sulfided, though such sulfiding may be conducted immediately prior to or concurrently with implementation. Catalysts within the scope of the invention may have a BET surface area in a range of from 100 to 200, 110 to 155, 115 to 150, 120 to 145, 125 to 140, 130 to 138, or 135 to 137 m²/g, e.g., a range using any of these end points. The support may have a BET surface area in a range of from 500 to 1,000, 600 to 800, 640 to 700, 641 to 690, 642 to 680, 643 to 670, 644 to 660, 645 to 650, or 646 to 648 m²/g, e.g., a range using any of these end points.

Inventive catalysts may have a microporous surface area in a range of from 5 to 50, 8.5 to 20, 9 to 18, 10 to 16, 11 to 15, 12 to 13 m²/g (or at least 10, 11, 12, 13, 14 or 15 m²/g), e.g., a range using any of these end points. The support may have a microporous surface area in a range of from 20 to 100, 40 to 80, 48.5 to 60, 48.75 to 57.5, 49 to 55, 49.25 to 52.5, or 49.5 to 50 (or no more than 47, 45, 40, 35) m²/g, e.g., a range using any of these end points.

Inventive catalysts may have an external surface area in a range of from 50 to 200, 100 to 145, 105 to 140, 110 to 135, 115 to 130, 120 to 128, or 122 to 126 m²/g, e.g., a range using any of these end points. The support may have an external surface area in a range of from 500 to 1,000, 592 to 650, 593 to 640, 594 to 630, 595 to 620, 596 to 610, or 597 to 600 m²/g (or less than 590, 580, 570, 560, 550, 540, or 530 m²/g), e.g., a range using any of these end points.

Catalysts within the scope of the invention may have a microporous pore volume in a range of from 0.005 to 0.0200, 0.0055 to 0.0105, 0.0056 to 0.01, 0.0058 to 0.009, 0.0059 to 0.0085, 0.006 to 0.008, 0.0062 to 0.0075, 0.0064 to 0.007, or 0.0064 to 0.0068 cm³/g, e.g., a range using any of these end points. The support may have a microporous pore volume in a range of from 0.01 to 0.04, or 0.015 to 0.0275 (0.24) cm³/g, e.g., a range using any of these end points.

Inventive catalysts may have a total pore volume in a range of from 0.200 to 0.500, 0.305 to 0.375, 0.31 to 0.37, 0.315 to 0.365, 0.32 to 0.36, 0.325 to 0.355, 0.33 to 0.35, 0.335 to 0.345, or 0.339 to 0.342 cm³/g, e.g., a range using any of these end points. The support may have a total pore volume in a range of from 0.75 to 1.5, 0.85 to 1.1, 0.9 to 1.09, 0.95 to 1.08, 1.0 to 1.075, or 1.05 to 1.067 cm³/g, e.g., a range using any of these end points.

Catalysts within the scope of the invention may have an average pore size in a range of from 7 to 15, 7.75 to 12.5, 8 to 12, 8.25 to 11.5, 8.5 to 11, 8.75 to 10.5, 9 to 10.25, or 9.5 to 10 nm, e.g., a range using any of these end points. The support may have an average pore size in a range of from 5 to 10, 6 to 8, 6.05 to 7.9, 6.1 to 7.75, 6.15 to 7.5, 6.2 to 7.25, 6.25 to 7.125, 6.33 to 7, 6.4 to 6.9, 6.5 to 6.8, or 6.6 to 6.7 nm, e.g., a range using any of these end points.

Aspects of the invention include methods of preparing catalyst, the method comprising: preparing a support comprising at least 80, 82.5, 85, 87.5, 90, 91, 92, 92.5, 93, 94, 95, 94.5, 96, 96.5, 97 wt. % (or more), based upon total support weight, mesoporous silica and cerium in a range of 0.1 to 10.0 or 1.5 to 4.5 wt. %, and/or at least 0.25, 0.33, 0.5, 0.67, 0.75, 0.85, 0.9, 1, 1.25, 1.33, 1.5, 1.67, 1.75, 1.8, 1.9, 2.0, 2.125, 2.25, 2.33, 2.4, or 2.5 wt. % and/or no more than 4.75, 4.67, 4.5, 4.33, 4.25, 4, 3.75, 3.67, 3.5, 3.33, 3.25, 3.125, 3, 2.85, 2.75, 2.67, or 2.5 wt. % Ce; and impregnating the support (possibly wet, semi-formed, precipitating, and/or in suspension) with a solution comprising a molybdenum salt, preferably a molybdate; impregnating the support with a solution comprising a cobalt salt; and heating, e.g., raising the reaction temperature, drying, and/or calcining, to obtain a supported CoMo catalyst suitable for hydrodesulfurization, particularly suitable after reduction and/or sulfiding as described herein or otherwise known in the art.

The preparing may comprise: mixing a tetraalkylorthosilicate, a surfactant—preferably uncharged, and an acid, preferably a mineral acid, to obtain a silica sol; adding to the silica sol a cerium alkoxide, preferably in an amount in a range of from 0.1 to 10, 0.5 to 8, 1 to 6, 1.5 to 5, or 2 to 4.5 wt. % relative to the tetraalkylorthosilicate, to obtain a cerium-containing silica sol; and heating the cerium-containing mesoporous silica sol at a temperature in a range of from 50 to 100, 60 to 95, 70 to 90, or 75 to 85° C., and/or at least 55, 65, 75° C. and/or no more than 100, 97.5, 92.5, or 87.5° C. The ratio of cerium alkoxide, preferably cerium isopropoxide, to silicate may be selected such that the Ce atom % or ceria content, relative to Si atom % or silica content such that the molar ratio CeO₂/SiO₂ or the atomic ration Ce/Si is varied between 0.01-0.1, preferably 0.02-0.08, or 0.04-0.06.

The tetraalkylorthosilicate may comprise tetramethylorthosilicate, tetraethylorthosilicate, tetrapropylorthosilicate, and/or tetrabutylorthosilicate. The surfactant may comprise a poly-alkylene oxide or polymer of a mixture of alkylene oxides, e.g., ethylene oxide, propylene oxide, oxetane, 1,2-butylene oxide, 2,3-butylene oxide, and/or THF. The acid or mineral acid may comprise hydrochloric acid, hydrobromic acid, and/or sulfuric acid, but may also or alternatively comprise acetic acid, triflic acid, perchloric acid, formic acid, chloric acid, and/or nitric acid. The cerium alkoxide may comprise cerium methoxide, cerium ethoxide, cerium propoxide, cerium isopropoxide, cerium sec-butoxide, and/or cerium tert-butoxide. The percent of any of these species of the tetraalkylorthosilicate, alkylene oxide monomer, acid, and/or cerium alkoxide may be at least 75, 80, 85, 90, 91, 92, 92.5, 93, 94, 95, 96, 97, 97.5, 98, 99, 99.1, 99.5, or 99.9 wt. % of a total weight of the respective genus. For example, the HCl may be 99 wt. % of the total acid weight used in the reaction. In copolymers for the surfactant, the total wt. % of components must be 100%, so the respective monomers may be 20, 25, 30, 33, 35, 40, 45, 50, 55, 60, 65, 67, or 70 wt. %, in addition to the percentages mentioned prior.

For example, the preparing may comprise: mixing tetraethylorthosilicate, PEO-PPO-PPO triblock copolymer, and hydrochloric acid to form a solution; adding cerium isopropxide in an amount in the range of 0.1 to 5, 0.5 to 4.5, 1 to 4, or 1.5 to 3 wt. % relative to the tetraethylorthosilicate; and heating at a temperature in a range of from 50 to 100° C. to produce the support, wherein the support is cerium-modified mesoporous silica having an average pore diameter in a range of, e.g., from 4 to 40, 4.5 to 30, 5 to 20, 5.5 to 15, or 6 to 10 nm.

The impregnating may comprise: mixing a suspension of the cerium-modified silica sol in water with an aqueous solution containing equimolar amounts of cobalt (II) chloride and/or other Co(II) salt described below, and ammonium molybdate(VI) and/or other Mo(IV) salt described below. The molar ratio of Co to Mo may also be, for example, in a range of 5:1 to 1:5, 4:1 to 1:4, 3:1 to 1:3, or 2:1 to 1:2.

The heating (of the catalyst reagent mixture) may comprise stirring and may be at a temperature in a range of from 40 to 60, 45 to 55, or 47.5 to 52.5° C. reaction temperature, e.g., for at least 15, 30, 45, 50, or 60 minutes and/or no more than 4, 3, 2, 1.5, or 1.2 hours, and optionally further heating to evaporate solvent, and optionally, calcining after the drying to obtain a supported CoMo catalyst within the scope of the invention. The further heating may be in the same temperature range as for the reaction, or, for example, at at least 60, 70, 80, 85, 90, 95, 100, 105, or 110° C., and the drying may be carried out for 4, 8, 12, 16, 20, 24, or 48 hours (or more). The calcining may be carried out at a temperature of at least 350, 400, 450, 500, 550, or 600° C., though generally no more than 1000, 800, 700, 600, or 550° C., and the calcining may be conducted for, e.g., 2, 3, 4, 5, or more hours. The supported catalyst material may be pressed into pellets, discs, or other shapes for transport and/or catalysis.

Inventive methods may further comprise activating the supported CoMo catalyst by a method comprising: reducing the supported CoMo catalyst under a flow of hydrogen (e.g., 5, 10, 15, 20, or 25 wt. %) in an inert gas, such as N₂, He, and/or Ar, at a temperature in a range of 350 to 450, 375 to 425, or 385 to 415° C., to obtain a reduced catalyst; and sulfiding the reduced catalyst, optionally with a solution comprising cyclohexane, pet ether, decaline, gasoline, pentane, toluene, xylenes, o-diclorobenzene, and/or, containing, e.g., carbon disulfide in the range of 0.5 to 4, 1 to 3.5, or 2 to 3 wt. % at a temperature in a range of 300 to 400, 310 to 390, 320 to 380, 330 to 370, or 340 to 360° C. to produce an activated catalyst. Any known sulfiding method and/or agent suitable for CoMo catalysts may be used, for example H₂S/H₂, dimethyl disulfide, diethyl disulfide, and/or di-t-butyl polysulfide. The sulfiding may occur in situ during initial implementation of the catalyst in a hydrodesulfurization process or reaction.

Aspects of the invention provide hydrodesulfurization methods, comprising: contacting a sulfur-containing hydrocarbon stream, such as crude oil, fraction(s) of crude oil, or a refined product, such as gasoline, kerosene, or diesel, with an activated catalyst as described herein under hydrogen (H₂) at a pressure in a range of, for example, 2 to 10, 3 to 9, 4 to 8, or 4.5 to 6 MPa (or even ambient pressure) and temperature in a range of 300 to 400° C. to thereby reduce a sulfur content of the hydrocarbon stream. The HDS temperature may be at least 300, 310, 315, 320, 325, 330, 333, 335, 340, 345, 350, 360, 365, 370, or 375° C. and/or no more than 390, 385, 380, 367, 365, 360, 355, or 350° C., or any of the lower endpoints may be the upper endpoint. The catalyst may be sufficient to remove at least 50, 60, 70, 75, 80, 85, 90, 91, 92, 92.5, 93, 94, 95, 96, 97, 97.5, 98, 99, 99.1, 99.5, or 99.9 wt. % of the sulfur in the original sulfur-containing petroleum stream after 2, 1.5, 1.25, 1, 0.75, 0.5, or 0.333 hours at 350° C. and 5 MPa H₂, e.g., using no more than 50, 40, 33, 30, 25, 20, 15, 10, 5, 4, 3, 2, 1, 0.5, 0.1, 0.001, or 0.0001 wt. % catalyst relative to the weight of the original petroleum stream.

Aspects of the invention include modifying the properties of the SBA-15 support by incorporation of cerium and/or ceria, optionally using a cerium isopropoxide precursor into the support's framework, and the resultant effect on the sulfided-CoMo catalyst for HDS of DBT. Catalytic activity of such catalysts can be directly correlated to the amount of Ce and formation of effective Ce—O—Si networks in the silica, e.g., SBA-15, support framework. The structural-activity of such catalysts can be established using X-ray diffraction (XRD), X-ray photoelectron spectroscopy (XPS), N₂ physisorption, Fourier transform infrared (FTIR), Raman spectroscopy, temperature programmed reduction (TPR), and electron microscope (SEM).

Aspects of the invention provide Ce-modified SBA-15 mesoporous materials as metal (oxide) catalyst supports with different wt. % Ce loading prepared by hydrothermal synthesis. The supports may be impregnated with Mo as the active metal followed by Co as the promoter via excess wet impregnation. Up to around 2.5 wt. % Ce may be preferably incorporated into the framework of the support, such as alumina, zirconia, titania, and/or silica, esp. mesoporous silica, such as SBA-15. Larger wt. % Ce in the support may rather incorporated into the extra framework of the support, such as SBA-15. The 2.5Ce—S—CoMo catalyst may have better active sites (MoS₂ phases) for HDS. The extra framework of SiO₂ is typically outside the Si—O—Si network. For example, the CeO₂ is introduced via the hydrothermal approach to form Si—O—Ce network (CeO₂ here is in the framework of SiO₂), but it was discovered that at high amounts of CeO₂, Si—O—Ce is not formed which indicates that CeO₂ is deposited on the SBA-15 surface and is not in the framework. Ce loading up to 2.5 wt. % may facilitate the reduction of MoO₃ and may prevent the formation of the inactive CoMoO₄ phase, resulting in better Mo reduction and dispersion. The 2.5Ce—S—CoMo may offer better HDS performance than unmodified (no Ce)S—CoMo and other Ce-modified SBA-15 supported CoMo catalysts in the series. Furthermore, even at a lower process temperature (325° C.) for HDS, 2.5Ce—S—CoMo and similar catalysts can perform better than S—CoMo at 350° C., e.g., 1.1, 1.25, 1.5, 1.75, 1.8, 1.9, 2, 2.125, 2.5-fold, or greater rates. At process temperatures of 375° C., 99.27% DBT may be removed within an hour of reaction. Therefore, 2.5Ce—S—CoMo catalysts and similarly modified/doped catalysts, may better efficiencies, potential for energy savings, and reduced refinery reaction times relative to undoped S—CoMo catalysts, and other Ce-doped variants.

Inventive catalysts will generally contain less than 15, 10, 7.5, 5, 2.5, 2, 1, 0.1, 0.01, 0.001, or 0.0001 wt. % of the total carrier weight of polyoxometalate(s) of the formula (HₕXₓMₘO_{y})^{q-}, either individually or as a group, wherein X is P, Si, B, Ni, or Co, M is Mo, W, Ni, and/or Co, h is an integer from 0 to 12, x is an integer from 0 to 4, m is an integer 5, 6, 7, 8, 9, 10, 11, 12 and/or 18, y is an integer of 17 to 72 and q is an integer of 1 to 20.

The total catalyst and/or total carrier weight for inventive catalysts may have less than 2.5, 2, 1.5, 1, 0.75, 0.5, 0.1, 0.01, 0.001 wt. % or only detectable amounts of Cr₂O₃, ZrO₂, V₂O₅, and/or NbOPO₄, either individually or as a group. The amount of phosphorous in active catalysts according to the invention will generally constitute less than 10, 5, 2.5, 1, 0.5, 0.1, 0.01, 0.001, 0.0001 wt. % or only detectable amounts, relative to the active catalyst weight and/or total catalyst weight.

While the undoped support may have pores and/or an average pore size greater than 50 nm in diameter, such pores and/or an average pore size will generally be greater than 2 and less than 50 nm in diameter, such as more than 3, 4, 5, 6, 7, 8, 9, or 10 nm, and/or less than 45, 40, 35, 30, 25, 20, 17.5, 15, 12.5, 10, or 9 nm. In some cases, separately or in addition, the support may have pores and/or an average pore size no more than 2 nm in diameter, e.g., less that 2, 1.5, 1, 0.9, 0.8, 0.75, 0.6, 0.5, 0.25, or 0.1 nm.

### EXAMPLES

MATERIALS: Ceric ammonium nitrate, ACS reagent grade, was procured from Riedel-de Haen AG, USA. Acetylacetone, dimethoxyethane, isopropanol, sodium hydride and sodium borohydride were procured from Fluka Chemie AG, Buchs, Switzerland. Tetraethyl-orthosilicate (TEOS), pluronic P123, i.e., a symmetric triblock copolymer comprising poly(ethylene oxide) (PEO) and poly(propylene oxide) (PPO) in an alternating linear fashion, PEO-PPO-PEO, with a molar mass (Mn) of ˜5,800 g/mol, anhydrous cobalt chloride (98%), DBT (98%), and dodecane were purchased from Sigma-Aldrich. Ammonium molybdate (VI) tetrahydrate (99%) was purchased from ACROS organics. Deionized water was generated in-house using a Thermo Scientific Barnstead NANOPURE filter after distillation with a Labstrong FiSTREEM™ II Glass Still distiller.

SYNTHESIS OF SBA-15 AND CE-MODIFIED SBA-15: Mesoporous SBA-15 and series of Ce-SBA-15 (1 to 10 wt. %) catalysts were synthesized, with slight modification (e.g., the addition of cerium isopropoxide to the acidic solution mixture of TEOS and Pluronic P123, in the synthesis of SBA-15, there was no addition of cerium isopropoxide), following the procedure described in Science 1998, 279(5350), 548-552, which is incorporated in its entirety herein by reference. The SBA-15 was prepared as described in Appl. Catal. B Environ. 2017, 203, 428-441, which is incorporated in its entirety herein by reference. The series of xCe-SBA-15 supports (where x represents Ce wt. %) were prepared by following the same SBA-15 procedure, except that equivalent amount of cerium isopropoxide was added to the acidic solution mixture of tetraethyl-orthosilicate and Pluronic 123 after stirring for 1.5 hours. The cerium isopropoxide was synthesized as reported in Chem. Eng. Res. Des. 2018, 132, 479-491, which is incorporated in its entirety herein by reference.

PREPARATION OF CATALYSTS: The SBA-15 and xCe-SBA-15 supported CoMo catalysts were prepared by impregnation of the Co and Mo active phase on the supports via excess wet solution method in deionized water. The method comprises stirring equivalent amounts of CoCl₂ and ammonium molybdate (VI) tetrahydrate at 50° C. for 1 hour, followed by adding an already dispersed solution of SBA-15 or xCe-SBA-15 in deionized water. The mixture, comprising the support and active catalyst metal, was further stirred until nearly all the deionized water is evaporated. The remaining solution was later dried in an oven at 80° C. for overnight, and subsequently calcined at 550° C. for 5 hours at ramping of 10° C./minute.

A description of the supports and catalysts synthesized is provided below in Table 1.

TABLE 1
Supports and catalysts description.

| Code | Description |
|---|---|
| SBA-15 | Mesoporous silica |
| xCe-SBA-15 | Ce modified SBA-15 with xCe wt. % loading |
| S—CoMo | SBA-15 impregnated with Co and Mo |
| XCe—S—CoMo | xCe-SBA-15 impregnated with Co and Mo |

As an alternative to CoCl₂, or a supplement to it, a variety of generally water soluble cobalt salts may be used, such as sulfates, halides, (bi)carbonates, (hydrogen)phosphates, hydroxides, perchlorates, borates, nitrates, oxalates, citrates, acetates, amino-acid salts, organic dicarboxylates, and/or (thio)cyanates, including (NH₄)₂Co(SO₄)₂, CoBr₂, CoI₂, CoCO₃, CoF₂, Co(OH)₂, Co(NO₃)₂, CoC₂O₄, Co(ClO₄)₂, Co₃(PO₄)₂, CoSO₄, Co(BF₄)₂, Co(SCN)₂, and/or hydrates of these, along with mixtures of these. In certain circumstances, Co(III) salts may be used, either as together with Co(II) salt(s) or separately, including, for example, [Co(NH₃)₆]Cl₃, [Co(NH₃)₅C]Cl₂, CoF₃, Co(OH)₃, or the like. As an alternative to (NH₄)₂MoO₄ and/or (NH₄)₆Mo₇O₂₄, or a supplement to it, a variety of generally water soluble cobalt salts may be used, including molybdates and other molybdenum oxides and sulfides, particularly those forming Mo(VI), such as Na₂MoO₄, K₂MoO₄, Li₂MoO₄, Cs₂MoO₄, MgMoO₄, CaMoO₄, MoS₂, MoCl₅, MoCl₃, MoO₂Cl₂, Na₂MoS₄, Ag₂MoO₄, BaMoO₄, SrMoO₄, Al₂(MoO₄)₃ and/or MoO₃, and/or hydrates and/or mixtures of these.

The surfactant used in the mixture for making the support may be a polyalkylene oxide, including PEO, PPO, and/or PBU, such as Pluronic-123. Such surfactants may have an Mn˜1,100, ˜1,900, ˜2,000, ˜2,700, ˜2,800, ˜3,300, or ˜5,800. In the case of Pluronic-123, the idealized structure may be HO—PEOₙ-PPOₘ—PEOₚ—H, wherein n and/or p are in a range of 15 to 25, 18 to 22, or 20, and/or m is in a range of 60 to 80, 64 to 76, 68 to 72, or 70. Exemplary SBA-15 supports may have an average particle size <150 μm; an average pore volume in a range of from 0.5 to 0.7, 0.7 to 0.9, or 0.8 to 1.00 cm³/g; average pore size of 4, 6, or 8 nm; and/or a surface area in a range of from 450 to 550, 700±50, or 750 to 850 m²/g.

Characterization of Supported Catalysts

The textural properties such as surface area, pore size and pore volume of the inventive catalysts were recorded on a Micromeritics ASAP 2020 using N₂ adsorption-desorption isotherms at 77 K. Prior to measurement, the catalysts were vacuum-degassed at 250° C. for 3 hour to remove impurities. The Brunauer, Emmett, and Teller (BET) method was used to calculate the surface area, and absorption branch of Barrett, Joyner, and Halenda (BJH) method was applied to calculate the pore size and pore volume of the catalysts.

X-RAY DIFFRACTION (XRD): The crystallinity of the supports and catalysts was determined by recording their XRD patterns between 10° to 90° 20 using Rigaku Ultima IV X-ray diffractometer. The operation was performed at 40 kV and 40 mA with a scanning speed of 10°/minute.

RAMAN SPECTROSCOPY: Raman spectra of the supports and catalysts were obtained using a HORIBA iHR320 with CCD detector Raman spectroscope. The spectroscope was operated at laser wavelength of 532 nm at room temperature.

FOURIER TRANSFORM INFRARED (FTIR) SPECTROSCOPY: The FT-IR spectra of inventive supports and catalysts were recorded on a Thermo Scientific Nicolet 6,700 FT-IR spectrometer over a wavenumber range of 400 to 4000 cm⁻¹. Samples were prepared by mixing 1% support/catalyst with KBr, pelletizing the crushed powder using an Atlas™ automatic press (8 ton) into a thin disc, and inserting the disc into the FTIR cell for the analysis.

TEMPERATURE-PROGRAMMED REDUCTION (H₂-TPR): The catalyst oxides' H₂-reducibility was determined by H₂-TPR with hydrogen as a probe molecule. The H₂-TPR analysis was carried out using an AutoChem II-2920 Micromeritics Chemisorption analyzer. Roughly 50 mg of respective calcined catalysts were heated to 500° C. for one (1) hour under the flow of high purity helium in order to remove impurities. After cooling to ambient temperature under the same helium flow, the gas flow was switched to 10% H₂ in helium (at steady flow of 20 mL/min) and the temperature was raised to 1000° C. at 10° C./minute ramping. Under these conditions, the amount of H₂ consumed at the reducible temperatures was recorded.

FIELD EMISSION SCANNING ELECTRON MICROSCOPY (FE-SEM): The morphology of sulfided catalysts were recorded on a FE-SEM instrument (TESCAN, LYRA 3) using a secondary electron (SE) imaging mode and a back scattered electron (BSE) imaging mode at an accelerating voltage of 20 kV.

X-RAY PHOTOELECTRON SPECTROSCOPY (XPS): The bonding states and binding energy of the sulfided catalysts were determined by XPS using a PHI 5000 Versa Probe II spectroscope (ULVAC-PHI Inc.). Disc-shaped pellets of samples of the catalysts were first subjected to high vacuum before the XPS analysis.

X-RAY FLUORESCENCE (XRF): The elemental composition of the sulfided catalysts were analyzed by XRF using a Bruker M4 TORNADO Micro-XRF equipped with 30 mm² Xflash® SD detector.

CATALYSTS PRESULFIDATION AND PERFORMANCE EVALUATION: The metal oxides in the catalysts, i.e., Co and Mo oxides, were reduced at 400° C. for 2 hours under a flow of 5% H₂/He in a quartz tubular furnace. After the 2 hours, the furnace temperature was brought down to 350° C. and 2 wt. % CS₂ in cyclohexane was flowed through the tubular furnace at the rate of 0.5 mL/min for 5 hours in order to presulfide the reduced metals. The presulfided catalysts were then pelletized to 300 to 500 microns.

The HDS performance of the presulfided catalysts was evaluated in a high-pressure Parr 4590 Micro Bench Top Reactor operated at a pressure of 5 MPa H₂ and 100 rpm stirring rate. Approximately 15 mg of the presulfided catalyst was added to 15 mL of model fuel containing 1000 ppm DBT in dodecane. The model reaction was performed for 4 hours after the reaction conditions stabilized, and product was sampled at hourly intervals.

Generally, the surface area and porosity of catalysts are important for elucidating the textural properties of the material. The textural properties of the SBA-15, Ce-modified SBA-15 supports, and the supported CoMo catalysts are presented in Table 2, below.

TABLE 2
Textural properties of supports and catalysts.

| | BET | Microporous | External | Microporous | Total | Average |
|---|---|---|---|---|---|---|
| | Surface | surface | surface | pore | pore | pore |
| Supports | area | area | area | volume | volume | size |
| catalysts | (m²/g) | (m²/g) | (m²/g) | (cm³/g) | (cm³/g) | (nm) |
| SBA-15 | 639.1 | 48.3 | 590.7 | 0.023 | 1.07 | 6.71 |
| 1Ce-SBA-15 | 607.6 | 38.1 | 569.4 | 0.018 | 1.01 | 6.73 |
| 2.5Ce-SBA-15 | 647.1 | 49.7 | 597.4 | 0.024 | 1.06 | 6.65 |
| 5Ce-SBA-15 | 575.4 | 47.5 | 527.9 | 0.023 | 0.95 | 6.68 |
| 10Ce-SBA-15 | 532.2 | 27.0 | 505.2 | 0.013 | 0.89 | 6.77 |
| S—CoMo | 157.7 | 10.4 | 147.3 | 0.0051 | 0.30 | 7.61 |
| 1Ce—S—CoMo | 117.7 | 8.9 | 108.8 | 0.0045 | 0.32 | 10.93 |
| 2.5Ce—S—CoMo | 136.8 | 12.1 | 124.0 | 0.0066 | 0.34 | 9.85 |
| 5Ce—S—CoMo | 124.9 | 17.2 | 107.7 | 0.0089 | 0.29 | 9.34 |
| 10Ce—S—CoMo | 131.8 | 17.4 | 114.4 | 0.0090 | 0.32 | 9.61 |

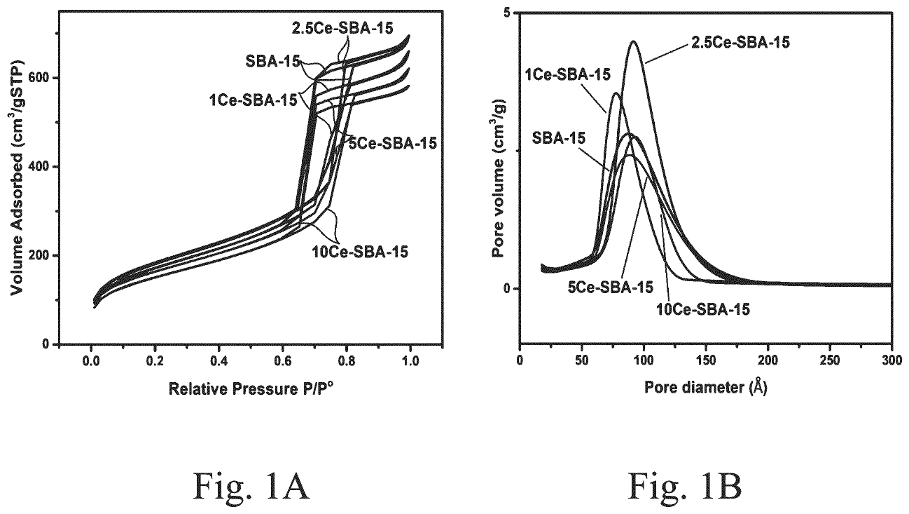

The BET surface area of the supports was observed to decrease continuously as the Ce wt. % loading increases except in 2.5Ce-SBA-15, in which the BET surface area increases by up to 8 m²/g. Possibly because low amounts of Ce ions in the sol-solution of the SBA-15 ease the incorporation of Ce into the SBA-15 framework. At high Ce ion concentrations in SBA-15 sol-solution, extra framework cerium oxide most probably forms, which could affect the surface area and pore volume of the Ce-modified SBA-15 synthesized, in addition to its catalytic properties as observed in 5Ce-SBA-15 and 10Ce-SBA-15 supports. The N₂ adsorption-desorption isotherms and the pore volume-size distribution of the supports presented in FIGS. 1A and B appear to confirm this hypothesis.

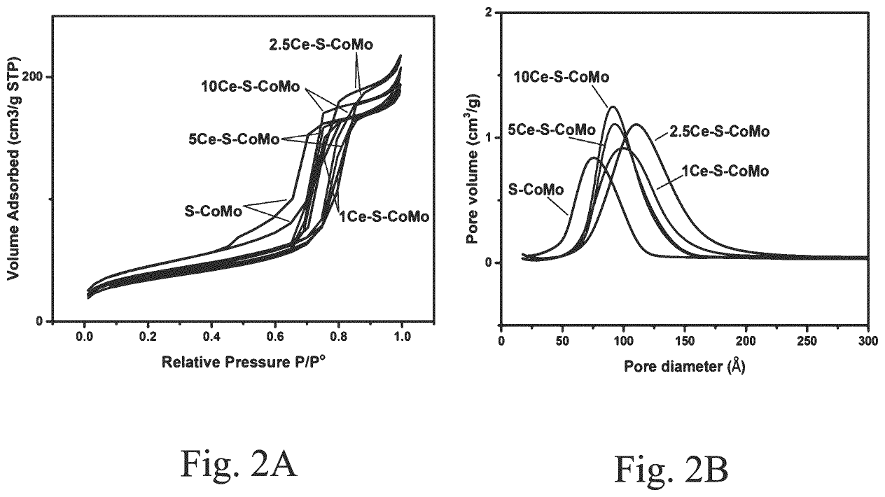

The slight decrease in the BET surface area of 1Ce-SBA-15 may imply that a 1 wt. % Ce loading provides insufficient Ce ion concentration to fill into the framework of the SBA-15 via ion-exchange of the Ce³⁺/Ce⁴⁺ with Si⁴⁺ of the SBA-15 during the hydrolysis and condensation process. The addition of Co and Mo to the supports by the impregnation approach exemplified herein and further sulfidation of the reduced active metals, however, gave decreased surface area and pore volume in all the catalysts due to the obstruction of some surface and void spaces. The 2.5Ce—S—CoMo catalyst showed higher surface area (136.8 m²/g) and total pore volume (0.34 cm³/g) than all the other Ce-modified SBA-15 supported CoMo catalysts (FIGS. 2A and B), thus putting the catalyst in a better position for catalytic performance.

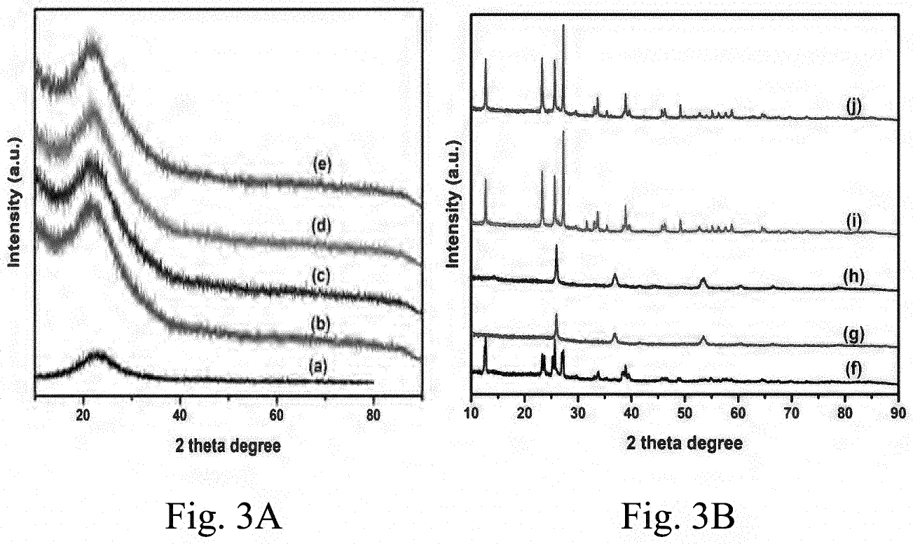

The X-ray diffraction (XRD) patterns of the supports and catalysts were performed to determine the crystallinity and dispersion of the sulfided active metals catalysts on the SBA-15 supports. FIG. 3A to E show the XRD patterns of all the supports prepared as described above, and FIG. 3F to J show the XRD spectra of sulfided, supported catalysts. At 2.5 Ce wt. % loading, excellent metal-support interaction was achieved, however, at ceria loading of 5 and 10 wt. %, the metal-support interaction may be large enough to deter the reduction of the Mo species.

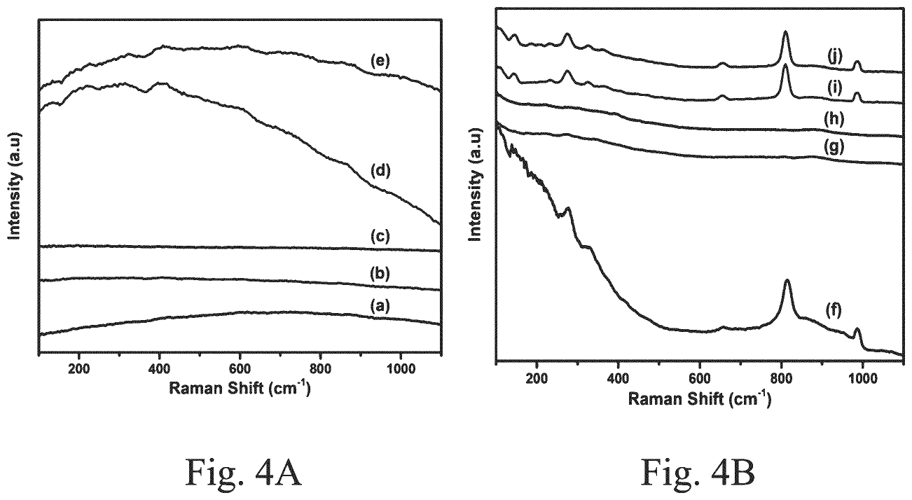

Raman spectroscopy is a sensitive tool for unraveling the molecular structure of Mo compounds. The Raman spectra of the supports are seen in FIG. 4A (a) to (e), and the Raman spectra of the supports and sulfided catalysts are seen in FIG. 4B (f) to (j). As discussed below, based on the Raman results for the sulfided, supported catalysts prepared as described herein, it may be inferred that Ce loading up to 2.5 wt. % in the catalyst supports increased the metal-support interaction to an optimum level that enhanced the molybdenum dispersion on the support, thereby easing Mo reduction and sulfidation.

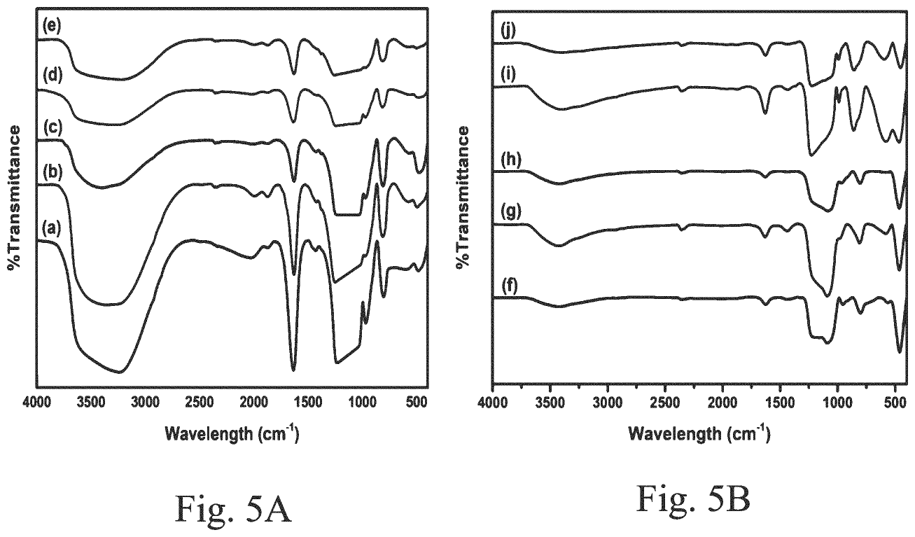

Fourier transform infrared (FT-IR) spectroscopy can provide information about the functional groups present in the supports and catalysts prepared as described herein, often complementing the Raman spectroscopy. The FT-IR spectra of the supports are shown in FIG. 5A (a) to (e), and the FT-IR spectra of the supported, sulfided catalysts are presented in FIG. 5B (f) to (j). As discussed below the red shift and diminished intensity of the broad band at 1240 cm⁻¹ indicates that Si—O—Si bond is being substituted with Si—O—Ce bond as the ceria loading increases, while the decrease or disappearance of the O—H stretching and bending vibration indicates filling of the free voids in the mesoporous supports by Co and Mo metals.

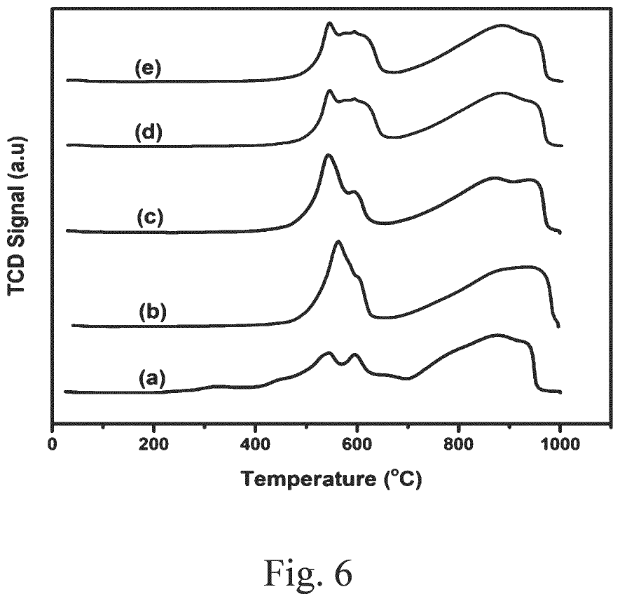

Temperature-programmed reduction (H₂-TPR) is a robust technique for studying the reducing pattern of metal oxides samples. H₂-TPR was performed on the inventive catalysts to gain some insight into the reducing behavior of the Ce-modified SBA-15 supported CoMo catalysts in their oxides form. The H₂-TPR profiles of the catalysts are shown in FIG. 6, and, as discussed in more detail below, the H₂-TPR results suggest that ceria incorporation into SBA-15 increases the mobility and activity of surface oxygen species and that ceria incorporation aids the interaction of Co and Mo species.

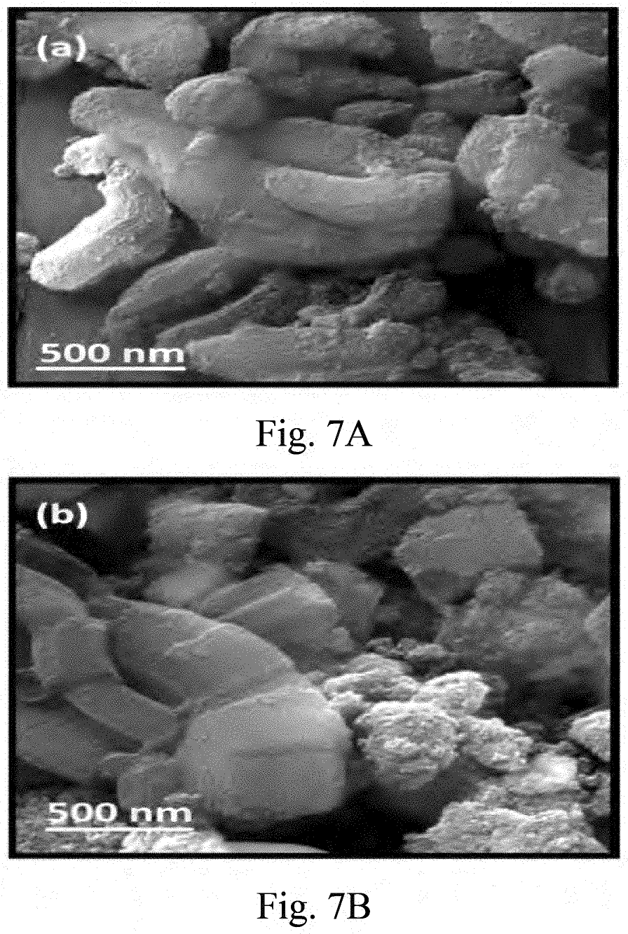

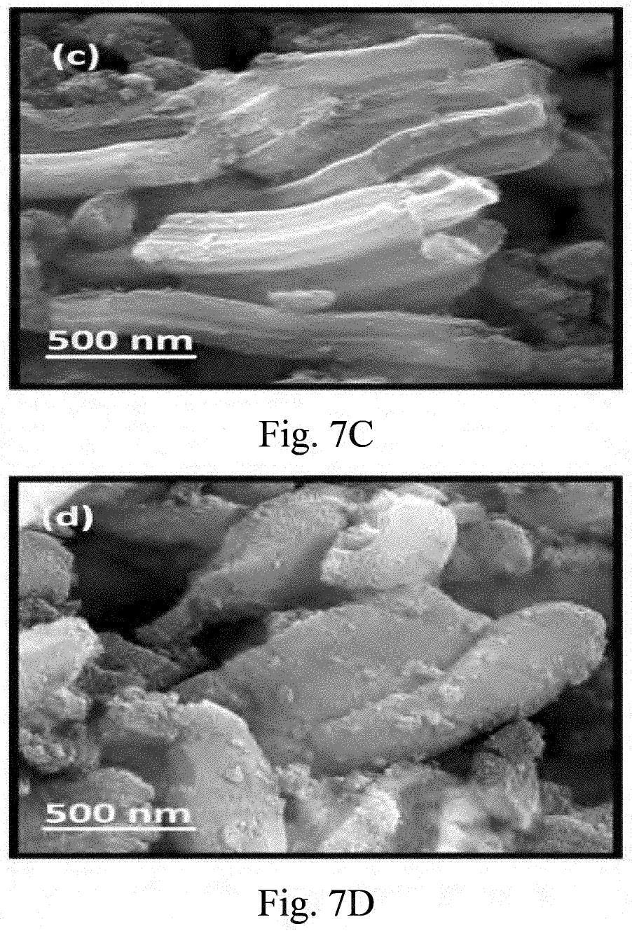

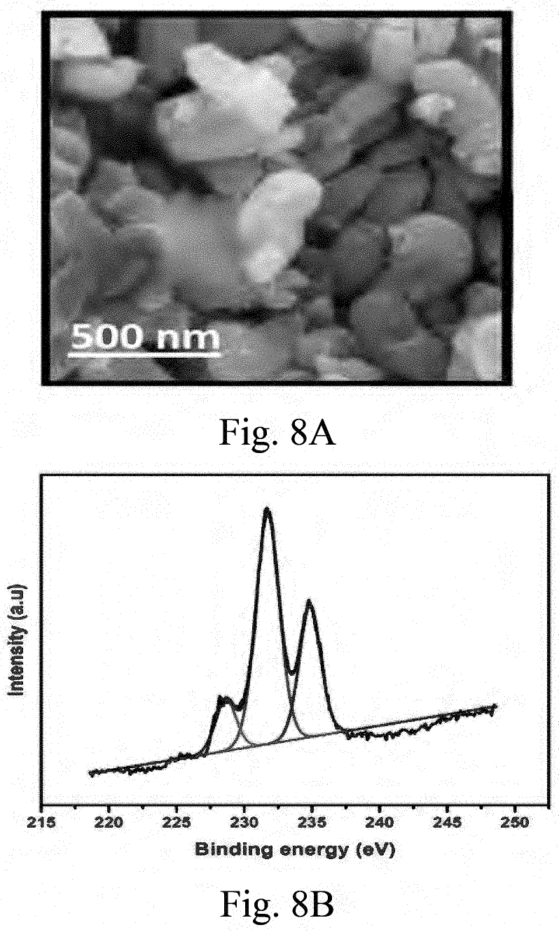

Field emission scanning electron microscopy (FE-SEM) was used for morphological examination of the S—CoMo (FIG. 8A) and Ce-modified SBA-15 supported CoMo catalysts (FIG. 7A to D). The FE-SEM images show hexagonally prismic and/or cylindrical short nano-rods with slight curvature, consistent with reported structures of mesoporous SBA-15. The hexagonally prismic and/or cylindrical nanorods may have average lengths in of at least 500, 600, 700, 750, 1000, 1250, 1500, 1750 nm and/or no more than 5000, 4500, 4000, 3500, 3000, 2500, 2250, 2000, and/or 1750 nm. The morphology of inventive catalysts may be that of a composite of parallel nanorods of the previously discussed lengths and cross-sectional diameters in a range of from, e.g., 0.2 to 5, 0.3 to 4, 0.4 to 3, 0.5 to 2, or 0.6 to 1 nm (these endpoints being interchangeable), agglomerated in parallel to form a composite, thicker nanorod. The length of the nano-rods was observed to increase with Ce wt. % loading on the support, indicating modified mesoporous SBA-15 properties. The particle density on the surface of the inventive catalysts due to the Co and Mo loading indicates a gradual increase in the particle density from S—CoMo to 2.5Ce—S—CoMo. However, the particle density of the catalyst surfaces decreases at higher Ce loading, i.e., 5Ce—S—CoMo and 10Ce—S—CoMo, which may be correlated to increased metal-support interaction from ceria loading on the SBA-15. With around 2.5 wt. % Ce, e.g., at least 0.5, 0.75, 1, 1.25, 1.5, 1.75, 1.8, 1.9, 2, 2.1, 2.125, 2.2, 2.25, 2.33, 2.40, 2.5, or 2.6 wt. % Ce, and/or up to 4.75, 4.5, 4.25, 4, 3.75, 3.5, 3.33, 3.25, 3.125, 3.1, 3.05, 3, 2.95, 2.9, 2.85, 2.8, 2.75, 2.7, 2.67, 2.625, or 2.6 wt. % Ce, the Co and Mo interaction with the support appears to be at its optimum. At around 2.5 wt. % Ce, optimum CoMo metal dispersion on the Ce-modified support. Higher Ce loading, i.e., over 5+0.5, 1, or 1.5 wt. % Ce, appears to result in stronger metal-support interactions, apparently causing aggregation of the metal crystallites and low particle density, a result which would corroborate the XRD and H₂-TPR results.

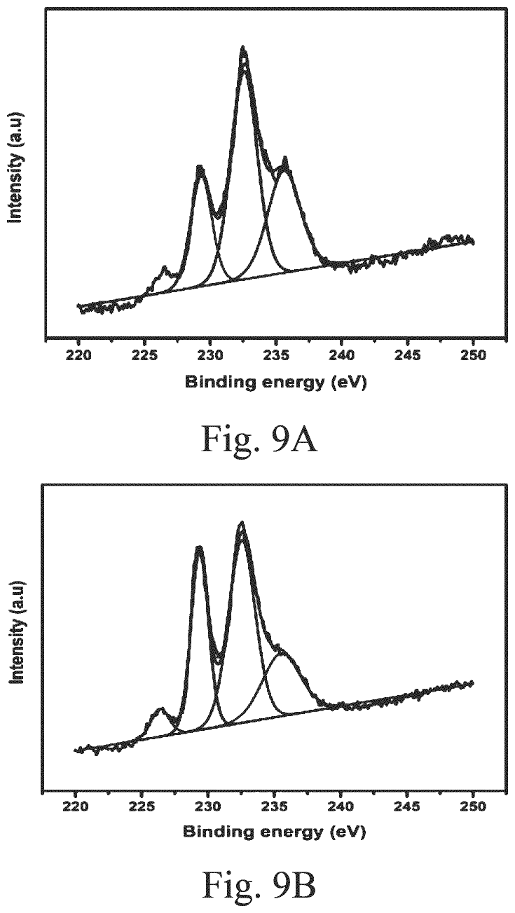

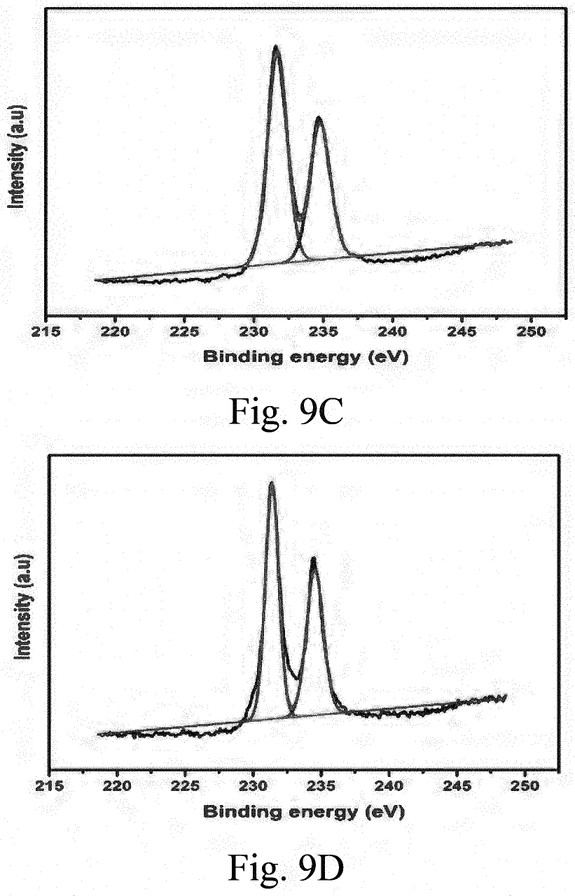

X-ray photoelectron spectroscopy (XPS) spectra show various binding states and binding energies of the Mo phases in the sulfided catalysts as presented in FIG. 8B and FIG. 9A to D. Though XPS is a surface analysis technique, it is often utilized to gain some insight in to the degree of sulfidation of the Mo species. As shown in Table Si below, three Mo species, distinguished by their unique binding energies, were mapped out from the deconvoluted XPS spectra.

TABLE S1
Different types of Mo phases in the catalysts

| | Percent molybdenum in various oxidation states | | |
|---|---|---|---|
| Catalysts | Mo⁴⁺ (3d_{5/2}) | Mo⁶⁺ (3d_{5/2}) | Mo⁶⁺ (3d_{3/2}) |
| Binding energy | 229.5 eV | 231.8 eV | 235.6 eV |
| S—CoMo | 11.51 | 58.24 | 30.25 |
| 1Ce—S—CoMo | 20.86 | 30.16 | 48.98 |
| 2.5Ce—S—CoMo | 33.44 | 44.59 | 21.97 |
| 5Ce—S—CoMo | — | 40.92 | 59.08 |
| 10Ce—S—CoMo | — | 44.16 | 55.84 |

Identification of peaks in the XPS spectra indicate MoS₂, with MoS₂, with Mo⁴⁺ (3d_{5/2}), and MoO₃ with Mo⁶⁺ (3d_{5/2}) and Mo⁶⁺ (3d_{3/2}), species in the developed catalysts. However, the atomic percent of the Mo species was found to vary among the S—CoMo and xCe—S—CoMo catalysts. The XPS peak characteristic of MoS₂ increased from S—CoMo (undoped) up to 2.5Ce—S—CoMo then became undetectable in higher ceria loaded catalysts. This may further explain the ease of Mo sulfidation when ceria (up to around 2.5 wt. %) is incorporated into the SBA-15 framework. The only observed XPS peak in 5Ce—S—CoMo and 10Ce—S—CoMo is the MoO₃ peak, which is in agreement with the XRD result obtained for the catalysts.

The constituent elements in the catalysts prepared as described herein were evaluated using a non-destructive X-ray fluorescence (XRF) technique, and summarized in Table 3, below.

TABLE 3
Elemental composition by XRF.

Elements (%)

| Catalysts | Si | O | Ce | Co | Mo |
|---|---|---|---|---|---|
| S—CoMo | 17.45 | 74.38 | — | 0.28 | 7.89 |
| 1Ce—S—CoMo | 17.47 | 75.25 | 0.19 | 0.27 | 6.82 |
| 2.5Ce—S—CoMo | 17.51 | 72.82 | 0.45 | 0.32 | 8.90 |
| 5Ce—S—CoMo | 15.26 | 76.22 | 0.79 | 0.32 | 7.41 |
| 10Ce—S—CoMo | 16.16 | 73.96 | 1.63 | 0.34 | 7.91 |

The presence of silicon and oxygen elements in large percent confirms the formation of (SBA-15) silica support in all the catalysts. The modification of the (SBA-15) silica with Ce was further verified by the increasing weight percent of elemental Ce determined in the synthesized catalysts. The disparity in the recorded weight percent, i.e., 0.19, 0.45, 0.79, and 1.63 wt. % Ce, and the theoretical weight percent, i.e., 1, 2.5, 5, and 10 wt. % Ce, may have resulted from addition of the Co and Mo metals after support modification and/or from inaccuracies in the calibration of the determination method. On average, Co appears to have been well incorporated in all the supports, and in nearly the same amount as determined by XRF. Unlike Ce, the Mo weight percent across all the catalysts, as determined by XRF was found to vary significantly. The 2.5Ce—S—CoMo catalyst indicates the highest Mo loading of 8.90 wt. % by XRF, which is 1.01 wt. % more than the Mo loading in S—CoMo, and likely due to the larger surface area of the 2.5Ce—S—CoMo catalyst.

The 1Ce—S—CoMo indicates an Mo loading of 6.82 wt. % by XRF, even lower than 5Ce—S—CoMo and 10Ce—S—CoMo. A possible reason for this observation is that, even though 1Ce—S—CoMo has larger surface area than 5Ce—S—CoMo and 10Ce—S—CoMo, the metal-support interaction in the 5Ce and 10Ce catalysts may be more pronounced, as observed by XRD, H₂-TPR, and Raman. This increased metal-support interaction in the 5Ce and 10Ce catalysts could attracts more Mo metal than in 1Ce—S—CoMo catalyst.

PRESULFIDATION CATALYSTS AND PERFORMANCE EVALUATION: The performance of the inventive catalysts, evaluated by percent dibenzothiophene (DBT) removal, is shown in Table 4, below.

TABLE 4
Catalyst performance results: Percent DBT removal. (Process
conditions: 350° C.; 5 MPa; DBT = 1000 ppm; reaction time = 4 h).

Percent DBT removal (%)

| Catalysts | 1 h | 2 h | 3 h | 4 h |
|---|---|---|---|---|
| S—CoMo | 32.43 | 49.65 | 65.49 | 82.50 |
| 1Ce—S—CoMo | 64.89 | 70.71 | 93.46 | 97.93 |
| 2.5Ce—S—CoMo | 73.54 | 90.42 | 94.6 | 98.14 |
| 5Ce—S—CoMo | 29.40 | 47.94 | 64.94 | 88.9 |
| 10Ce—S—CoMo | 36.11 | 50.72 | 83.86 | 89.85 |

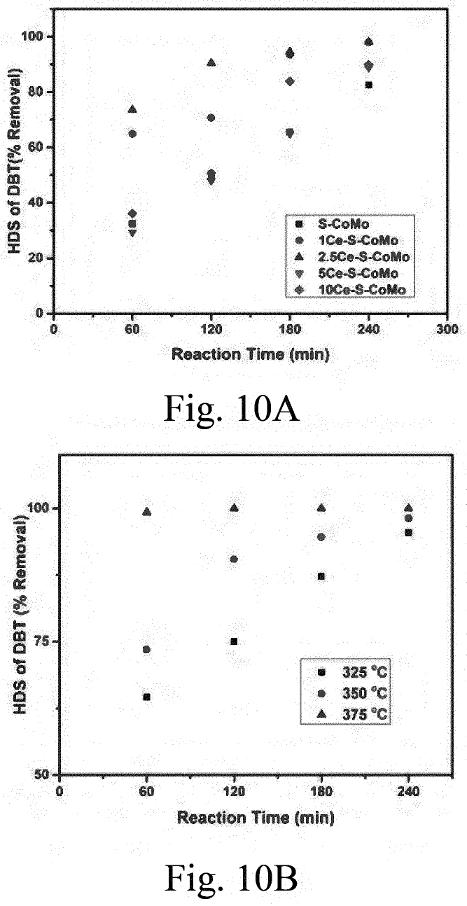

Under the model reaction conditions, the hydrodesulfurization (HDS) of DBT followed a reaction performance pattern hypothesized based on the analytical determinations about the inventive catalysts. Within the first one hour of reaction after achieving the stabilized reaction conditions, S—CoMo removed up to 32.43% sulfur from a 1000 ppm DBT solution of dodecane, as seen in FIG. 10A. This percent removal was almost doubled (64.89%) when 1Ce—S—CoMo was used as the HDS catalyst. The performance further increased by 8.65% when 2.5Ce—S—CoMo was applied as the HDS catalyst. However, reduction in catalytic activity was observed when 5Ce—S—CoMo and 10Ce—S—CoMo catalysts were used in the HDS reaction. The observed conversion trends continued for 4 hours in all the catalysts, and by the end of the 4th hour, 98.14% sulfur had already been removed from the 1000 ppm DBT in HDS using the 2.5Ce—S—CoMo catalyst. The percent sulfur removal by catalyst followed the trend: 5Ce—S—CoMo<10Ce—S—CoMo<S—CoMo<1Ce—S—CoMo<2.5Ce—S—CoMo.

A further study was carried out on the effect of temperature on the HDS reaction for the best performing catalyst in the study above, i.e., 2.5Ce—S—CoMo. Results of the temperature study presented below in Table S2, as well as in FIG. 10B.

TABLE S2
Effect of process temperature for 2.5Ce—S—CoMo (5 MPa;
DBT = 1000 ppm; reaction time = 4 h).

| | Percent sulfur removal (%) at different temperature | | | |
|---|---|---|---|---|
| Temperature (° C.) | 1 h | 2 h | 3 h | 4 h |
| 325 | 64.58 | 75.01 | 87.23 | 95.46 |
| 350 | 73.54 | 90.42 | 94.6 | 98.14 |
| 375 | 99.27 | 100 | 100 | 100 |

As seen in Table S2, 64.58% of sulfur was removed after the first 1 hour of the HDS reaction at a process temperature of 325° C. This 2.5Ce—S—CoMo removal rate is twice the activity of S—CoMo at a process temperature of 350° C. Advantageously, the HDS reaction can be studied and/or conducted successfully at lower process temperatures by incorporating 2.5 wt. % Ce into the mesoporous silica, such as SBA-15, which could offer refineries substantial energy savings. At a (higher) process temperature of 375° C. using 2.5Ce—S—CoMo in HDS, nearly complete sulfur removal (99.27%) was achieved within the first one hour of reaction. The rapid efficacy using a 2.5Ce—S—CoMo catalyst in the HDS of DBT, could likewise offer energy savings due to decreased reaction times relative to S—CoMo in HDS.

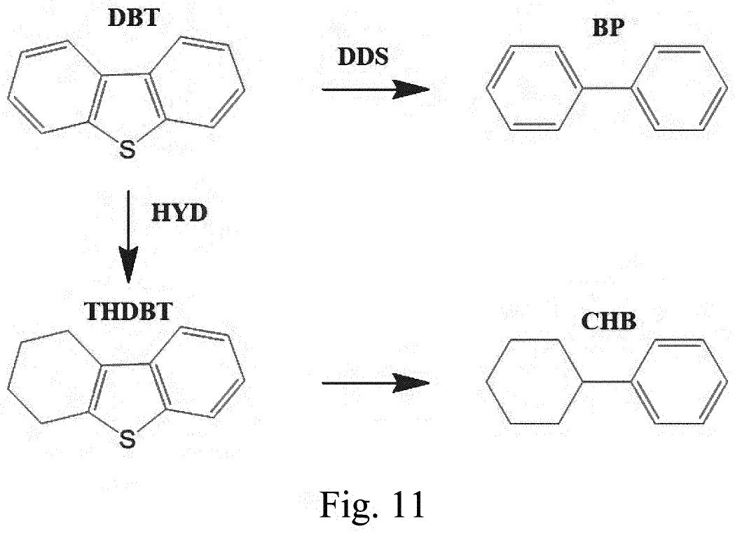

The mechanism of HDS on DBT has been reported to occur via two pathways as shown in FIG. 11: (1) one-step, direct desulfurization (DDS) involving direct C—S bond cleavage to form biphenyl (BP); and (2) hydrogenation (HYD) of phenyl ring to cyclohexyl in two to three steps, then C—S bond cleavage to form cyclohexyl benzene (CHB). Both of these pathways, (1) and (2), are accompanied by the release of H₂S.

A detailed analysis of the product distribution after 1 hour of the model HDS reaction is summarized below in Table 5.

TABLE 5
Catalyst performance results: Product Distribution (%) after 1 h. (Process
conditions: 350° C.; 5 MPa; DBT = 1000 ppm).

| | Product distribution (%) | | | | |
|---|---|---|---|---|---|
| Catalysts | CPB | CHB | BP | THDBT | BP/CHB |
| S—CoMo | | 5.54 | 94.46 | — | 17.05 |
| 1Ce—S—CoMo | — | 13.82 | 86.18 | — | 6.24 |
| 2.5Ce—S—CoMo | — | 15.53 | 84.47 | — | 5.44 |
| 5Ce—S—CoMo | — | 9.68 | 87.90 | 2.42 | 9.08 |
| 10Ce—S—CoMo | — | 6.14 | 93.84 | — | 15.28 |

In each of the studied catalysts, diphenyl (BP) stands out as the significantly largest product of the HDS reaction, suggesting that a substantial part of the reaction using CoMo on silica occurs via the (one-step) DDS pathway. A trend in the BP formation across all the studied catalysts could be observed in that the amount of BP appears to decrease when Ce is incorporated to SBA-15 up to the 2.5 wt. % Ce. However, at Ce loading of 5 wt. %, the % BP increased, and at 10 wt. %, the % BP has reached almost the same amount as that of S—CoMo.

The ratio of BP to cyclohexyl benzene (CHB) maintained the same trend as that observed in BP, indicating that Ce plays a role in the reaction pathway, apparently tending to lead the reaction to the HYD pathway as evidenced in the % CHB increase due to Ce loading up to 2.5 wt. %. HYD promotion of Ce may be associated with the Ce⁴⁺↔Ce³⁺ redox properties in the Ce-modified SBA-15 support. The low % CHB at 5 and 10 wt. % Ce may be associated with strong metal-support interactions weakening the Ce⁴⁺↔Ce³⁺ redox properties, hence decreasing the HYD promoter behavior of Ce.

The effect of temperature variation on the product distribution using 2.5Ce—S—CoMo catalyst is presented in Table S3, below.

TABLE S3
Catalyst performance results: Product distribution
(%) after 1 h for 2.5Ce—S—CoMo at varying temperatures
(Process conditions: 5 MPa; DBT = 1000 ppm).

| | Product distribution (%) | | | | |
|---|---|---|---|---|---|
| Temp | CPB | CHB | BP | THDBT | BP/CHB |
| 325 | | 14.46 | 85.54 | — | 5.92 |
| 350 | — | 15.53 | 84.47 | — | 5.44 |
| 375 | — | 16.05 | 83.95 | — | 5.23 |

As seen in Table S3, the % CHB increases with increasing temperature, resulting in decreased BP/CHB. Typically, the DDS pathway can be modified to include a sequential HYD of BP to CHB. Although the alternate mechanism (DBT→BP→CHB) is less probable, this alternate route may explain the increased % CHB at high temperature.

A kinetic study was performed on the assumption that the HDS reaction occur completely via the parallel pathway (i.e., where as shown in FIG. 11, in the parallel pathway the hydrodesulfurization reaction occurs via both direct desulfurization pathway (DSS) and the hydrogenation pathway (HYD) at the same time), and that the reaction rate is calculated based on the pseudo-first order kinetics. Thus, calculated rate constants of the HDS reaction, k_{HDS} (min⁻¹), DDS reaction, k_{DDS} (min⁻¹), and HYD reaction, k_{HYD} (min⁻¹) are presented below in Table 6.

TABLE 6
First-order rate constants for HDS of
DBT after 1 h reaction time at 350° C.

| | k_{HDS} × 10³ | k_{DDS} × 10³ | k_{HYD} × 10³ | k_{DDS}/ |
|---|---|---|---|---|
| Catalysts | (min⁻¹) | (min⁻¹) | (min⁻¹) | k_{HYD} |
| S—CoMo | 6.53 | 6.17 | 0.36 | 17.14 |
| 1Ce—S—CoMo | 17.44 | 15.03 | 2.41 | 6.24 |
| 2.5Ce—S—CoMo | 22.16 | 18.72 | 3.44 | 5.44 |
| 5Ce—S—CoMo | 5.80 | 5.23 | 0.58 | 9.02 |
| 10Ce—S—CoMo | 7.47 | 7.01 | 0.46 | 15.24 |

The k_{HDS}(min⁻¹) for the S—CoMo catalyst was calculated to be 6.53×10⁻³, comparing well to the k_{HDS} (8.4×10⁻³ min⁻¹) reported for Ti-modified SBA-NiMo catalyst prepared and sulfided under the same conditions.

The role of Ce in the catalysts can also be expressed based on the rate constants of the HDS reaction. The k_{HDS} (min⁻¹) was observed to increase by a factor of 3.4 from S—CoMo to 2.5Ce—S—CoMo catalysts. The increase in k_{HDS} (min⁻¹) was in-tandem with an increase in k_{HYD} (min⁻¹), resulting in decreased k_{DDS}/k_{HYD}, as observed in the BP/CHB product distribution in Table 5. However, above 2.5 Ce wt. %, the k_{HDS} (min⁻¹) and k_{HYD} (min⁻¹) decreased significantly.

The effect of temperature on the k_{HDS} (min-1) for 2.5Ce—S—CoMo catalyst was studied. As shown below in Table S4, increasing the process temperature from 350 to 375° C. increases the k_{HDS} (min⁻¹) by a factor of 3.7. However, increasing the process temperature from 350 to 375° C. also increases the HYD pathway, thus leading to a decrease in k_{DDS}/k_{HYD}.

TABLE S4
Effect of temperature on first-order rate constants for
HDS of DBT (catalyst = 2.5Ce—S—CoMo).

| Temperature | k_{HDS} × 10³ | k_{DDS} × 10³ | k_{HYD} × 10³ | k_{DDS}/ |
|---|---|---|---|---|
| (° C.) | (min⁻¹) | (min⁻¹) | (min⁻¹) | k_{HYD} |
| 325 | 17.30 | 14.80 | 2.50 | 5.92 |
| 350 | 22.16 | 18.72 | 3.44 | 5.44 |
| 375 | 82.00 | 68.64 | 13.16 | 5.22 |

Overall, the HDS activity of 2.5Ce—S—CoMo catalyst is unexpectedly superior to S—CoMo, as evidenced by the k_{HDS} (min⁻¹) values, among other data herein. In fact, the 2.5Ce—CoMo is the best performing catalyst among the series of Ce-modified SBA-15 CoMo catalyst. The performance of 2.5Ce—S—CoMo catalyst may derive from its textural properties and a moderate metal-support interaction observed from the XRD, Raman spectroscopy, and H₂-TPR results.

Referring now to the drawings, wherein like reference numerals designate identical or corresponding parts throughout the several views.

FIGS. 1A and B respectively show (A) N₂ adsorption-desorption isotherms and (B) pore volume-size distributions of the exemplary supports prepared within the scope of the invention. FIGS. 2A and B respectively show (A) N₂ adsorption-desorption isotherms and (B) pore volume-size distributions of the exemplary supported catalysts prepared within the scope of the invention.

FIG. 3A shows XRD patterns of all the supports, i.e., SBA-15 (a); 1Ce-SBA-15 (b); 2.5Ce-SBAA-15 (c); 5Ce-SBA-15 (d); and 10Ce-SBA-15 (e), each indicating a broad diffraction peak between 20° to 30° which is a typical characteristic peak of amorphous silica. However, CeO₂ diffraction peak was not observed in any of the supports, implying that ceria (up to 10 wt. % loading) has been incorporated into the mesoporous SBA-15 silica. The XRD spectra of sulfided catalysts—S—CoMo (f); 1Ce—S—CoMo (g); 2.5Ce—S—CoMo (h); 5Ce—S—CoMo (i); and 10Ce—S—CoMo (j)—presented in FIG. 3B show the MoO₃ phase pattern with a quality mark (QM) of “Star,” i.e., well characterized chemically and crystallographically with no unindexed lines at Δ2θ≤0.03°, for S—CoMo, 5Ce—S—CoMo, and 10Ce—S—CoMo. However, 1Ce—S—CoMo and 2.5Ce—S—CoMo show an MoS2 phase pattern with a QM of “I,” i.e., well characterized chemically with no unindexed strong line at Δ2θ≤0.06°. The peaks intensity of the MoO₃ phase follow the trend: S—CoMo<5Ce—S—CoMo<10Ce—S—CoMo, while the peak intensity of MoS₂ phase follow the trend: 1Ce—S—CoMo<2.5Ce—S—CoMo. This indicates that the ease of sulfidation follows the trend 2.5Ce—S—CoMo>1Ce—S—CoMo S—CoMo>5Ce—S—CoMo>10Ce—S—CoMo. The observed sulfidation trend may be ascribed to the role of ceria on the metal-support interaction. At 2.5 wt. % Ce loading, the optimum metal-support interaction appears to have been achieved. However, at ceria loading of 5 and 10 wt. %, the metal-support interaction may be large enough to deter the reduction of the Mo species.

FIG. 4A shows the Raman spectra of the supports synthesized as described above: SBA-15 (a); 1Ce-SBA-15 (b); 2.5Ce-SBAA-15 (c); 5Ce-SBA-15 (d); and 10Ce-SBA-15 (e). The Raman spectra of the supports show very weak peaks at 605 and 850 cm⁻¹ which were assigned to the vibrational stretching mode of the surface hydroxyl group in Si—OH and the symmetrical stretching of the Si—O—Si linkage respectively. Close observation of the Raman spectra of the 5 wt. % and 10 wt. % Ce-modified SBA-15 supports reveals a Raman band at 420 cm⁻¹. This band is a characteristic Raman band of cerium oxide reported elsewhere in the literature, meaning that at high ceria loading some of the cerium ions are not attached to the Si—O—Si framework of SBA-15. This undergirds the hypothesis that high cerium concentration most probably forms external and/or additional framework cerium oxide in the textural properties of the supports.

FIG. 4B shows the Raman spectra of the supported, sulfided catalysts synthesized as described above: S—CoMo (f); 1Ce—S—CoMo (g); 2.5Ce—S—CoMo (h); 5Ce—S—CoMo (i); and 10Ce—S—CoMo (j). The Raman spectra of the sulfided catalysts showed peaks at 284, 665, 815, and 993 cm⁻¹ for S—CoMo, 5Ce—S—CoMo, and 10Ce—S—CoMo, which are characteristic bands for MoO₃, known in the literature. The Raman peaks at 284 and 665 cm⁻¹ are assigned to the wagging modes of the terminal oxygen atoms and asymmetric stretching of the Mo—O—Mo, while the bands at 815 and 993 cm⁻¹ are ascribed to the symmetric stretching and asymmetric stretching of the terminal oxygen in MoO₃. The presence of the MoO₃ phase in the sulfided S—CoMo, 5Ce—S—CoMo, and 10Ce—S—CoMo catalysts indicates that some of the molybdenum species have not been completely reduced (and consequently further sulfided) in the catalysts prepared as described herein.

However, these MoO₃ Raman bands were not observed in the 1Ce—S—CoMo and 2.5Ce—S—CoMo. Instead Raman frequencies of vibrational modes of S—Mo—S (385 and 407 cm⁻¹) were detected. Therefore, it may be inferred that Ce loading up to 2.5 wt. % in the catalyst supports increased the metal-support interaction to an optimum level that enhanced the molybdenum dispersion on the support, thereby easing Mo reduction and sulfidation.

FIG. 5A shows the FT-IR spectra of the supports prepared as described above: SBA-15 (a); 1Ce-SBA-15 (b); 2.5Ce-SBAA-15 (c); 5Ce-SBA-15 (d); and 10Ce-SBA-15 (e). The appearance of broad peak at 3300 to 3500 cm⁻¹ in all the samples prepared may be attributed to the stretching vibration of Si—OH present in the SBA-15 channels and the O—H stretching of water absorbed on the surfaces of the supports and catalysts. The sharp peak observed at 1600 cm⁻¹ may be assigned to the O—H bending vibration of the absorbed water molecules. The peak intensities of both O—H peaks appear to decrease proportionately with ceria loading in the support, indicating that some of the SBA-15 pores may be occupied due to ceria loading. The broad band at 1240 cm⁻¹ may be assigned to the Si—O—Si stretching vibration, and the wavenumber of this broad band was observed to increase slightly with ceria loading. At 10Ce-SBA-15, the wavenumber is approximately 1300 cm⁻¹. In addition, the intensity of the broad band also decreases with ceria loading, also indicating that Si—O—Si bonds are substituted with Si—O—Ce bonds as the ceria loading increases.

FIG. 5B shows the FT-IR spectra of the supported, sulfided catalysts prepared as described above: S—CoMo (f); 1Ce—S—CoMo (g); 2.5Ce—S—CoMo (h); 5Ce—S—CoMo (i); and 10Ce—S—CoMo (j). After loading of Co and Mo onto the supports, the broad peak at 3300 to 3500 cm⁻¹ and the sharp peak at 1600 cm⁻¹ for the O—H stretching and bending vibration of absorbed water molecules respectively noticeably decreased, indicating that free voids in the mesoporous supports may be filled with the loaded Co and Mo metals.

FIG. 6 shows the temperature-programmed reduction (H₂-TPR) profiles of the catalysts prepared as described above: S—CoMo (a); 1Ce—S—CoMo (b); 2.5Ce—S—CoMo (c); 5Ce—S—CoMo (d); and 10Ce—S—CoMo (e). Each of the metal oxide catalyst samples shows two major peaks at approximately 575° C. and 900° C., which may be respectively assigned to the reduction of molybdenum oxide: MoO₃ to MoO₂; and MoO₂ to Moo. The reducing temperature of the inventive catalysts was observed to slightly decrease as the ceria loading increased, up to 2.5 wt. % loading, suggesting that ceria incorporation into the SBA-15 support framework increases the mobility and activity of surface oxygen species due to the redox behavior of Ce (Ce⁴⁺↔Ce³⁺) and the formation of oxygen vacancy.

By implication, more Mo species should have close contact with the Ce-modified support in the doped rather than unmodified SBA-15 support, thus resulting in less sintering and more dispersion of Mo in Ce-modified supported catalysts. However, above 2.5 wt. % Ce loading, a sharp increase in the reduction temperature was observed, implying that ceria loading up to 5 and 10 wt. % increases the metal-support interaction abruptly, inhibiting the reduction of the MoO₃. These H₂-TPR results support the results obtained from the wide angle XRD, discussed above. Close analysis of the S—CoMo TPR profile in FIG. 6, plot (a), reveals a shoulder peak at 324.6° C., similar to a peak reported in the art. The shoulder/peak has been explained to arise from the reduction of cobalt oxide to cobalt metal, indicating that some cobalt species in the S—CoMo have separated from interacting with Mo species. This 324.6° C. shoulder is absent in the Ce-modified SBA-15 supported CoMo catalysts, supporting the hypothesis that ceria incorporation into the silica aids Co and Mo interaction.

FIG. 7A to D show field emission scanning electron microscopy (FE-SEM) images of the Ce-modified SBA-15 supported CoMo catalysts, while FIG. 8A shows an FE-SEM of the S—CoMo catalyst (undoped). FIG. 8B and FIG. 9A to D respectively show the x-ray photoelectron spectroscopy (XPS) spectra of the Mo phases in the sulfided catalysts S—CoMo catalyst (undoped) then the various Ce-modified SBA-15 supported CoMo catalysts.

FIG. 10A shows exemplary catalyst performances for the catalysts prepared as described herein, undoped or with the various Ce modifications, for a hydrodesulfurization (HDS) reaction on dibenzothiophene (DBT) in a model fuel (dodecane)—removing sulfur from a 1000 ppm DBT solution in dodecane. FIG. 10B show a study of the effect of temperature on the HDS reaction for the best performing catalyst in the study from FIG. 10A, i.e., 2.5Ce—S—CoMo. FIG. 11 shows the reported reaction mechanism of HDS on DBT via the two proposed pathways: (1) one-step, direct desulfurization (DDS) involving direct C—S bond cleavage to form biphenyl (BP); and (2) hydrogenation (HYD) of phenyl ring to cyclohexyl in two to three steps, then C—S bond cleavage to form cyclohexyl benzene (CHB).

Numerous modifications and variations of the present invention are possible in light of the above teachings. It is therefore to be understood that within the scope of the appended claims, the invention may be practiced otherwise than as specifically described herein.

1: A catalyst, comprising:
an active component comprising Co and Mo, and suitable to catalyze hydrodesulfurization; and
a support comprising at least 80 wt. %, based on the total weight of the support, mesoporous silica and cerium in a range of 0.1 to 10.0 wt. %.

2: The catalyst of claim 1, wherein the amount of cerium in support is in a range of from 1.5 to 4.5 wt. %.

3: The catalyst of claim 1, wherein the cerium is present as ceria.

4: The catalyst of claim 1, wherein the mesoporous silica has an average pore diameter in a range of from 3 to 20 nm.

5: The catalyst of claim 1, wherein the mesoporous silica is SBA-15.

6: The catalyst of claim 1, which is sulfided.

7: The catalyst of claim 1, having a BET surface area in a range of from 110 to 155 m²/g,
and/or
wherein the support has a BET surface area in a range of from 640 to 700 m²/g.

8: The catalyst of claim 1, having a microporous surface area in a range of from 8.5 to 20 m²/g,
and/or
wherein the support has a microporous surface area in a range of from 48.5 to 60 m²/g.

9: The catalyst of claim 1, having an external surface area in a range of from 100 to 145 m²/g,
and/or
wherein the support has an external surface area in a range of from 595 to 650 m²/g.

10: The catalyst of claim 1, having a microporous pore volume in a range of from 0.0055 to 0.0105 cm³/g,
and/or
wherein the support has a microporous pore volume in a range of from 0.015 to 0.0275 cm³/g.

11: The catalyst of claim 1, having a total pore volume in a range of from 0.305 to 0.375 cm³/g,
and/or
wherein the support has a total pore volume in a range of from 0.85 to 1.1 cm³/g.

12: The catalyst of claim 1, having an average pore size in a range of from 7.75 to 12.5 nm,
and/or
wherein the support has an average pore size in a range of from 6 to 8 nm.

13: A method of preparing a catalyst, the method comprising:
preparing a support comprising at least 80 wt. %, based upon total support weight, mesoporous silica and cerium in a range of 0.1 to 10.0 wt. %; and
impregnating the support with a solution comprising a molybdenum salt;
impregnating the support with a solution comprising a cobalt salt; and
heating to obtain a supported CoMo-catalyst suitable for hydrodesulfurization.

14: The method of claim 13, wherein the preparing comprises:
mixing a tetraalkylorthosilicate, a surfactant, and a mineral acid, to obtain a silica sol;
adding to the silica sol a cerium alkoxide in an amount in a range of from 0.1 to 10 wt. % relative to the tetraalkylorthosilicate, to obtain a cerium-containing silica sol; and
heating the cerium-containing mesoporous silica sol at a temperature in a range of from 50 to 100° C.

15: The method of claim 14, wherein the tetraalkylorthosilicate comprises tetramethylorthosilicate, tetraethylorthosilicate, tetrapropylorthosilicate, and/or tetrabutylorthosilicate,
wherein the surfactant is uncharged,
wherein the mineral acid comprises hydrochloric acid, hydrobromic acid, sulfuric acid, and/or
wherein the cerium alkoxide comprises cerium methoxide, cerium ethoxide, cerium propoxide, cerium isopropoxide, cerium sec-butoxide, and/or cerium tert-butoxide.

16: The method of claim 13, wherein the preparing comprises:
mixing tetraethylorthosilicate, PEO-PPO-PPO triblock copolymer, and hydrochloric acid to form a solution;
adding cerium isopropxide in an amount in the range of 0.1 to 5 wt. % relative to the tetraethylorthosilicate; and
heating at a temperature in a range of from 50 to 100° C. to produce the support, wherein the support iscerium-modified mesoporous silica having an average pore diameter in a range of from 4 to 40 nm.

17: The method of claim 13, wherein the impregnating comprises:
mixing a suspension of the cerium-modified silica sol in water with an aqueous solution containing equimolar amounts of cobalt (II) chloride and ammonium molybdate(VI).

18: The method of claim 13, wherein the heating comprises stirring at a temperature in a range of from 40 to 60° C. to evaporate solvent, and optionally, calcining to obtain the supported CoMo catalyst.

19: The method of claim 13, further comprising activating the supported CoMo catalyst by a method comprising:
reducing the supported CoMo catalyst under a flow of hydrogen in an inert gas at a temperature in a range of 350 to 450° C., to obtain a reduced catalyst; and
sulfiding the reduced catalyst, optionally with cyclohexane containing an amount of carbon disulfide in the range of 0.5 to 4 wt. % at a temperature in a range of 300 to 400° C. to produce an activated catalyst.

20: A hydrodesulfurization method, comprising:
contacting a sulfur-containing hydrocarbon stream with an activated catalyst under hydrogen at a pressure in a range of 2 to 10 MPa and temperature in a range of 300 to 400° C. to thereby reduce a sulfur content of the hydrocarbon stream,
wherein the activated catalyst comprises (i) an active component comprising Co and Mo, and suitable to catalyze hydrodesulfurization; and (ii) a support comprising at least 80 wt. %, based upon total support weight, mesoporous silica and cerium in a range of 0.1 to 10.0 wt. %, and the active catalyst is sulfided.
